(19) United States
(12) Patent Application Publication
(10) Pub. No.: US 2025/0222687 A1
(43) Pub. Date: Jul. 10, 2025

(54) LAMINATING DEVICE, PROCESSING METHOD FOR ELECTRODE PLATE ASSEMBLY, AND THERMALLY BONDING DEVICE FOR ELECTRODE PLATES

(71) Applicant: EVE POWER CO., LTD., Jingmen (CN)

(72) Inventors: Weibo LI, Jingmen (CN); Liquan CHEN, Jingmen (CN); Bin SU, Jingmen (CN); Wei CHEN, Jingmen (CN); Dingding YUAN, Jingmen (CN)

(73) Assignee: EVE POWER CO., LTD., Jingmen (CN)

(21) Appl. No.: 19/015,286

(22) Filed: Jan. 9, 2025

(30) Foreign Application Priority Data
Jan. 9, 2024 (CN) 202410034237.5
Apr. 10, 2024 (CN) 202410431353.0
Apr. 10, 2024 (CN) 202420745017.9
May 29, 2024 (CN) 202421212877.2
Sep. 26, 2024 (WO) PCT/CN2024/121315

(51) Int. Cl. B32B 39/00; B32B 37/06; B32B 37/10; B32B 38/00; B32B 38/18; H01M 4/04

(52) U.S. Cl. CPC B32B 39/00; B32B 37/06; B32B 37/10; B32B 38/0012; B32B 38/1833; H01M 4/0435; B32B 2307/7375; B32B 2309/14; B32B 2309/72; B32B 2457/10

(57) ABSTRACT

A laminating device, a processing method for the electrode plate assembly, and a thermally bonding device for electrode plates are provided. The laminating device includes a laminating platform, a first driving roller assembly, and a second driving roller assembly. A first spacing d1 is arranged between the first driving roller assembly and the second driving roller assembly. A length of each of the electrode plate units is L, d1 is less than L, or d1 is greater than L, and a ratio between d1 and Lis a non-integer.

### CROSS-REFERENCE TO RELATED APPLICATION

The present Application claims priorities to International Application No. PCT/CN2024/121315, filed on Sep. 26, 2024, as well as Chinese Applications No. 202410431353.0, and 202420745017.9, filed on Apr. 10, 2024; No. 202410034237.5, filed on Jan. 9, 2024; and No. 202421212877.2, filed on May 29, 2024, the contents of which are incorporated herein by reference.

### TECHNICAL FIELD

The present application relates to the field of battery technology, and in particular to a laminating device, a processing method for electrode plate assembly and a thermally bonding device for electrode plates.

### BACKGROUND

Lamination technology of a lithium battery is mainly divided into four types: Z-shaped lamination, cutting-laminating integration, winding-laminating integration, and thermally bonding lamination. Thermally bonding lamination process is high in production efficiency and has become a new favorite in the field of lamination technology. The thermally bonding lamination is a process in which positive electrode plates, diaphragms, and negative electrode plates are thermally bonded with each other to form thermally bonded electrode plate units, and then the thermally bonded electrode plate units are laminated to form an electrode plate assembly.

In the related art, the thermally bonded electrode plate units are driven to fall and laminate through a single driving roller to control the movement of the thermally bonded electrode plate units. Since the driving roller is designed as a pair of rollers, a clamping force of the driving roller on the thermally bonded electrode plate units is adjusted through a spacing between the pair of rollers. The clamping force of the two driving rollers on the thermally bonded electrode plate units is configured at a contact line of the pair of rollers, and the spacing between the two driving rollers is configured to be able to clamp the thermally bonded electrode plate units. A spaced area is arranged between two adjacent thermally bonded electrode plate units, as well as between the thermally bonded electrode plate units of an upper cell pack and a lower cell pack. The spaced area is formed with only two diaphragms, while the thermally bonded electrode plate unit is composed of one positive electrode plate, one negative electrode plate, and two diaphragms.

### SUMMARY

In the related art, the spacing between two driving rollers is nonadjustable. Therefore, in case that a spaced area is arranged between the two driving rollers, since the two driving rollers are configured to be unable to clamp the spaced area, the falling and laminating process of the thermally bonded electrode plate units is out of control, which affects the alignment of a cell pack and an energy density of a battery.

In a first aspect, embodiments of the present application provide a laminating device configured for processing an electrode plate assembly, the electrode plate assembly includes multiple electrode plate units, and the laminating device includes:
a laminating platform, configured for laminating the multiple electrode plate units;
a first driving roller assembly and a second driving roller assembly, arranged at intervals on a same side of the laminating platform, and configured for clamping the electrode plate assembly to drive the electrode plate assembly to move;
in which a first spacing is arranged between the first driving roller assembly and the second driving roller assembly, the first spacing is set to be d1, a length of each of the electrode plate units is set to be L, d1 is less than L, or d1 is greater than L, and a ratio between d1 and L is a non-integer.

In a second aspect, embodiments of the present application provide a processing method for an electrode plate assembly, the electrode plate assembly is processed through a laminating device, and the processing method includes:
providing multiple electrode plate units, in which each of the electrode plate units includes a positive electrode plate, a first diaphragm, a negative electrode plate, and a second diaphragm laminated in sequence;
driving a first driving roller assembly and a second driving roller assembly, in which the electrode plate units are driven through both the first driving roller assembly and the second driving roller assembly to move towards a direction close to a laminating platform, and the electrode plate units pass through the first driving roller assembly and the second driving roller assembly in sequence; and
laminating the multiple electrode plate units through the laminating platform to form a battery cell pack.

In an embodiment, the processing method further includes:
adjusting position of the first driving roller assembly on a first support platform, and/or adjusting position of the second driving roller assembly on a second support platform, thereby adjusting positions of the electrode plate units relative to the laminating platform.

In a third aspect, embodiments of the present application provide a thermally bonding device for electrode plates, the thermally bonding device for electrode plates includes the laminating device as described above and a hot rolling device. The hot rolling device is configured for hot rolling positive electrode plates, diaphragms, and negative electrode plates to form thermally bonded electrode plate units and then providing the thermally bonded electrode plate units to the laminating device.

### BRIEF DESCRIPTION OF THE DRAWINGS

FIG. 1 is a schematic diagram of a structure of a thermally bonding device for electrode plates provided in a first embodiment of the present application;

FIG. 2 is a three-dimensional diagram of an electrode plate assembly provided in the first embodiment of the present application;

FIG. 3 is an exploded view of an electrode plate assembly provided in the first embodiment of the present application;

FIG. 4 is a three-dimensional diagram of a laminating device provided in the first embodiment of the present application from one perspective;

FIG. 5 is a three-dimensional diagram of a laminating device provided in the first embodiment of the present application from another perspective;

FIG. 6 is a three-dimensional diagram of a laminating device provided in the first embodiment of the present application from still another perspective;

FIG. 7 is a partially enlarged view of FIG. 6;

FIG. 8 is a three-dimensional diagram of a first driving roller assembly provided in the first embodiment of the present application;

FIG. 9 is a partially enlarged view of FIG. 8;

FIG. 10 is a three-dimensional diagram of a second driving roller assembly provided in the first embodiment of the present application;

FIG. 11 is a partially enlarged view of FIG. 10;

FIG. 12 is a three-dimensional diagram of a laminating device provided in a second embodiment of the present application from one perspective;

FIG. 13 is a three-dimensional diagram of a laminating device provided in the second embodiment of the present application from another perspective;

FIG. 14 is a flow chart of one thermally bonding process provided in a third embodiment of the present application;

FIG. 15 is a flow chart of another thermally bonding process provided in the third embodiment of the present application;

FIG. 16 is a schematic diagram of a structure of a laminating device in the related art;

FIG. 17 is a three-dimensional diagram of a laminating device provided in the third embodiment of the present application from one perspective;

FIG. 18 is a top view of a laminating platform provided in the third embodiment of the present application;

FIG. 19 is an enlarged view of part A in FIG. 17;

FIG. 20 is an enlarged view of part B in FIG. 18;

FIG. 21 is a three-dimensional diagram of a laminating device provided in an embodiment of the present application from another perspective; and

FIG. 22 is a three-dimensional diagram of a laminating device provided in an embodiment of the present application from still another perspective.

### DETAILED DESCRIPTION

### First Embodiment

Lamination technology of a lithium battery is mainly divided into four types: Z-shaped lamination, cutting-laminating integration, winding-laminating integration, and thermally bonding lamination. Thermal bonding lamination process is high in production efficiency and has become a new favorite in the field of lamination technology. The thermally bonding lamination is a process in which positive electrode plates, diaphragms, and negative electrode plates are thermally bonded with each other to form thermally bonded electrode plate units, and then multiple thermally bonded electrode plate units are laminated to form an electrode plate assembly in a single battery cell pack.

In the related art, the thermally bonded electrode plate units are driven to fall and laminate through a single driving roller assembly to control the movement of the thermally bonded electrode plate units. The driving roller assembly is designed of a pair of rollers, a clamping force of the driving roller assembly on the thermally bonded electrode plate units is adjusted through a spacing between the pair of rollers. The clamping force of the driving roller assembly on the thermally bonded electrode plate units is configured at a contact line of the pair of rollers, and the spacing between the two driving rollers is configured for being able to clamp the thermally bonded electrode plate units.

A spaced area is arranged between two adjacent thermally bonded electrode plate units, as well as between the thermally bonded electrode plate units of an upper cell pack and a lower cell pack. The spaced area is generally formed with two diaphragms, while the thermally bonded electrode plate unit is generally composed of one positive electrode plate, one negative electrode plate and two diaphragms. The spacing between the two driving rollers is nonadjustable. Therefore, when the spaced area is arranged in the spacing between the two driving rollers, since the spacing between the two driving rollers is greater than a thickness of the spaced area, the spaced area cannot be clamped through the driving roller assembly, and the falling and laminating process of the electrode plate assembly is out of control. When the falling and laminating process of one thermally bonded electrode plate unit is out of control, overhang would be occurred in a battery cell pack formed during preparation, in which overhang refers to the situation that the alignment between the positive electrode plate and the negative electrode plate cannot meet requirements, so that the alignment of the battery cell pack and the energy density of the battery are affected.

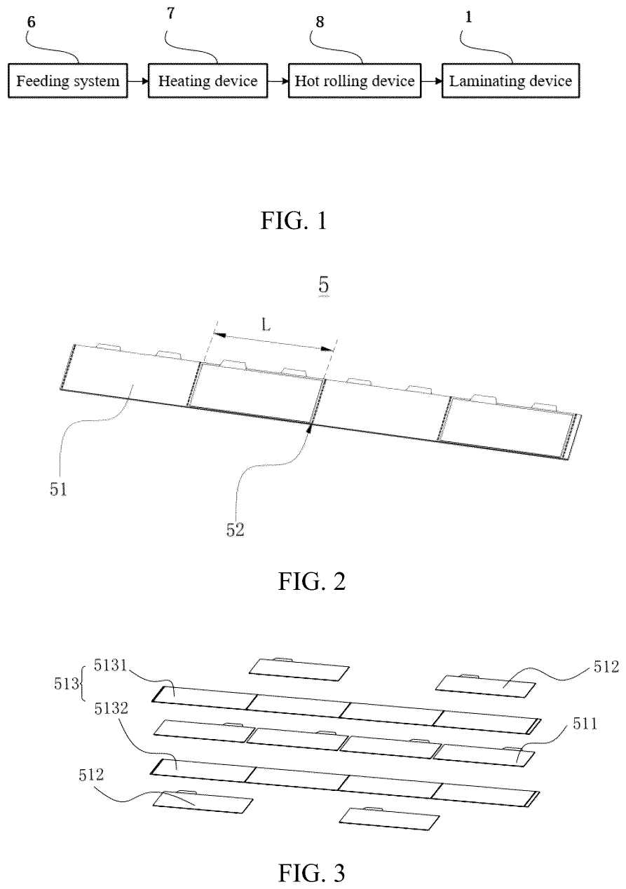

In the present application, structure of the driving roller assembly in a laminating device is improved. As shown in FIG. 1, some of the embodiments of the present application provide a thermally bonding device for electrode plates, which includes a feeding system 6, a heating device 7, a hot rolling device 8, and a laminating device 1.

The feeding system 6 includes a positive electrode plate feeding system, a negative electrode plate feeding system, a first diaphragm feeding system, and a second diaphragm feeding system. The positive electrode plate feeding system, the negative electrode plate feeding system, the first diaphragm feeding system, and the second diaphragm feeding system are all in operation. In the positive electrode plate feeding system, a roll of positive electrode plate 511 is cut into individual positive electrode plates 511, and the positive electrode plates 511 are transmitted to the heating device 7. In the negative electrode plate feeding system, a roll of negative electrode plate 512 is cut into individual negative electrode plates 512, and the negative electrode plates 512 are transmitted to the heating device 7.

As shown in FIG. 2 and FIG. 3, each of the thermally bonded electrode plate units 51 includes one positive electrode plate 511, one negative electrode plate 512, and two diaphragms 513. A single positive electrode plate 511, a first diaphragm 5131, a single negative electrode plate 512, and a second diaphragm 5132 are laminated inside the heating device 7 in sequence. The first diaphragm 5131 and the second diaphragm 5132 are configured as glue-coated diaphragms, and the glue-coated diaphragm heated through heating device 7 is sticky. The heated single positive electrode plate 511 and single negative electrode plate 512 are thermally bonded with the first diaphragm 5131 and the second diaphragm 5132 to form a bonded body. The bonded body is rolled and compacted through the hot rolling device 8 to form a thermally bonded electrode plate unit 51. Two adjacent thermally bonded electrode plate units 51 are connected through the spaced area 52.

Multiple continuous thermally bonded electrode plate units 51 are laminated through the laminating device 1 to form a battery cell pack. Two adjacent thermally bonded electrode plate units 51 are connected through the spaced area 52, and the thermally bonded electrode plate units 51 used in the two adjacent thermally battery packs are also connected through the spaced area 52, in which the spaced area 52 is configured with two diaphragms 513.

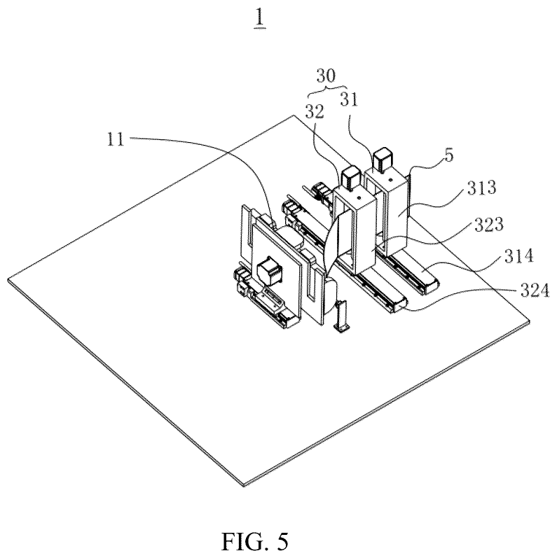

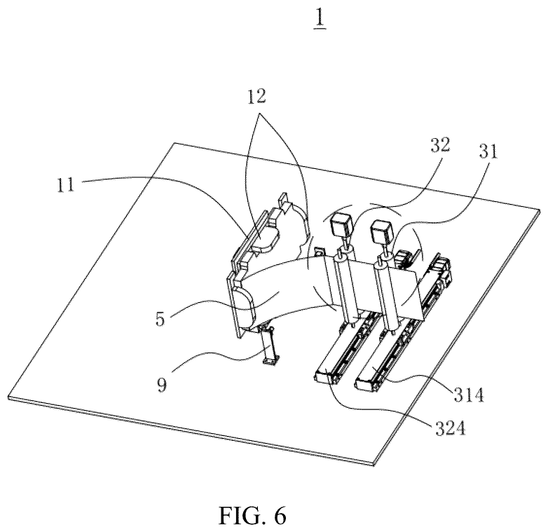

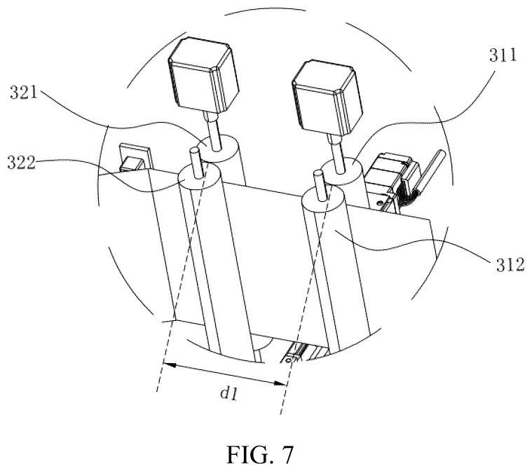

As shown in FIG. 2 to FIG. 7, in some of the embodiments provided in the present application, a structure of the driving roller assembly in the laminating device 1 is improved, so that the driving roller assembly can effectively control the falling and laminating process of the thermally bonded electrode plate assembly 5. Thus, the thermally bonded electrode plate units 51 are prepared through the laminating device 1 based on a predetermined falling and laminating route and speed to form a battery cell pack with high alignment.

Specifically, the laminating device 1 includes a laminating platform 11 and a driving mechanism 30.

The laminating platform 11 is configured for laminating multiple electrode plate units to form a battery cell, and the laminating platform 11 is located below the driving mechanism 30.

The driving mechanism 30 includes a first driving roller assembly 31 and a second driving roller assembly 32. The first driving roller assembly 31 and the second driving roller assembly 32 are arranged at intervals on the same side of the laminating platform 11. The first driving roller assembly 31 and the second driving roller assembly 32 are both configured for driving the thermally bonded electrode plate assembly 5 to move, and the first driving roller assembly 31 and the second driving roller assembly 32 are both configured to be able to clamp the electrode plate units.

A first spacing is arranged between the first driving roller assembly 31 and the second driving roller assembly 32, the first spacing is set to be d1, a length of each of the electrode plate units is set to be L, d1 is less than L, or d1 is greater than L, and a ratio between d1 and L is a non-positive integer.

In some embodiments, the ratio between d1 and L can be in a numerical range of 0.1˜0.9, 1.1˜1.9, 2.1˜2.9, 3.1˜3.9, 4.1˜4.9, 5.1˜5.9, 6.1˜6.9, 7.1˜7.9, 8.1˜8.9, or 9.1˜9.9, and a range in any of the numerical ranges, which are not listed one by one in the present application.

In embodiments of the present application, the falling and laminating process of the thermally bonded electrode plate assembly 5 is controlled through both the first driving roller assembly 31 and the second driving roller assembly 32, in which both the first driving roller assembly 31 and the second driving roller assembly 32 are configured to be able to clamp the thermally bonded electrode plate units 51. Through setting the first spacing dl between the first driving roller assembly 31 and the second driving roller assembly 32 to be less than the length L of each of the thermally bonded electrode plate units 51, or setting the first spacing dl to be greater than the length L of each of the thermally bonded electrode plate units 51, and setting the ratio between d1 and L to be a non-positive integer, during the falling and laminating process of the thermally bonded electrode plate units 51, when the spaced area 52 is located in one of the first driving roller assembly 31 and the second driving roller assembly 32, the thermally bonded electrode plate units 51 are located in another of the first driving roller assembly 31 and the second driving roller assembly 32, so that at least one of the first driving roller assembly 31 and the second driving roller assembly 32 can always provide a stable clamping effect on the thermally bonded electrode plate units 51, effectively preventing the thermally bonded electrode plate units 51 from being out of control during the falling and laminating process.

In some embodiments, when the spacing between the first driving roller assembly 31 and the laminating device 1 is small, the first spacing dl is set to be less than the length L of each of the thermally bonded electrode plate units 51. Therefore, when the spaced area 52 is located in the first driving roller assembly 31, the thermally bonded electrode plate unit close to the spaced area 52 is located in a second spacing of the second driving roller assembly 32, so that the second driving roller assembly 32 can provide stable clamping force to the thermally bonded electrode plate unit 51. If the first spacing dl is set to be equal to the length of each of the thermally bonded electrode plate units 51, the spaced area 52 is located in the first driving roller assembly 31, and a next spaced area 52 arranged close to the spaced area 52 is located in the second driving roller assembly 32, so that the second driving roller assembly 32 cannot provide stable clamping force to the thermally bonded electrode plate assembly 5 either, resulting in the falling and laminating process of the thermally bonded electrode plate assembly 5 out of control.

When the spacing between the first driving roller assembly 31 and the laminating platform 11 is large, the first spacing dl is set to be greater than the length of each of the thermally bonded electrode plate units 51, and the ratio between dl and L is set to be non-integer. Therefore, when the spaced area 52 is located in the first driving roller assembly 31, the thermally bonded electrode plate unit 51 should be located in the second spacing of the second driving roller assembly 32, so that the second driving roller assembly 32 can provide stable clamping force to the thermally bonded electrode plate unit 51.

Compared with related technologies in which the spacing of the driving roller assembly is set to be adjustable, in order to increase the thermally bonding speed of the electrode plate unit, the falling and laminating speed of the thermally bonded electrode plate assembly 5 is high, so that the spacing of the driving roller assembly cannot be adjusted instantly. Meanwhile, the spacing should be adjusted in combination with specific falling and laminating position of the thermally bonded electrode plate assembly 5, so that it is difficult to accurately and efficiently control the entire falling and laminating process of the thermally bonded electrode plate assembly 5. In embodiments of the present application, through arranging two driving roller assemblies on a moving path of the thermally bonded electrode plate assembly 5, while maintaining the falling and laminating speed of the thermally bonded electrode plate assembly 5 high, the situation where the spaced area 52 cannot be clamped through a single driving roller assembly, resulting in the falling and laminating process out of control can be improved.

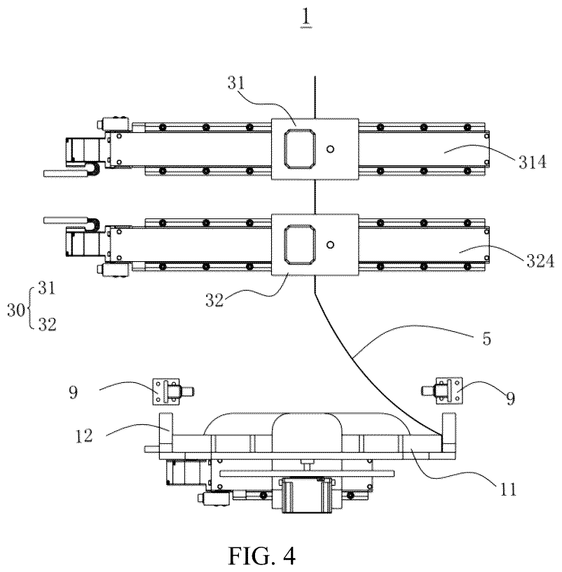

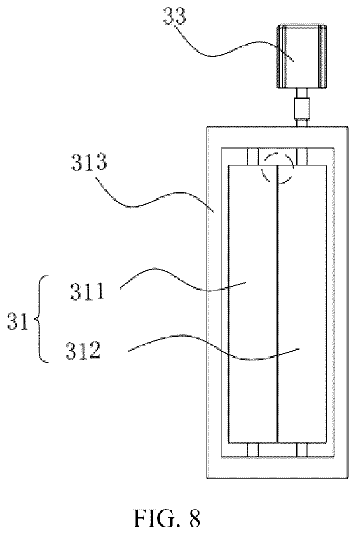

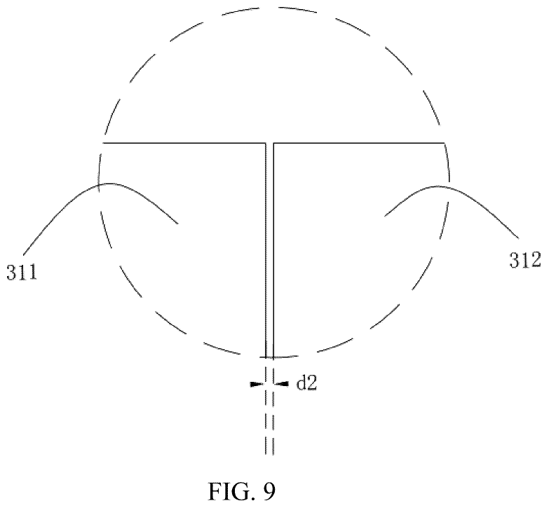

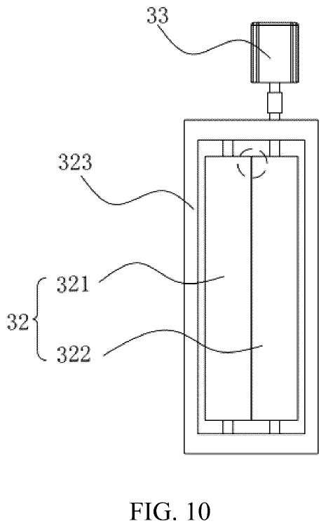

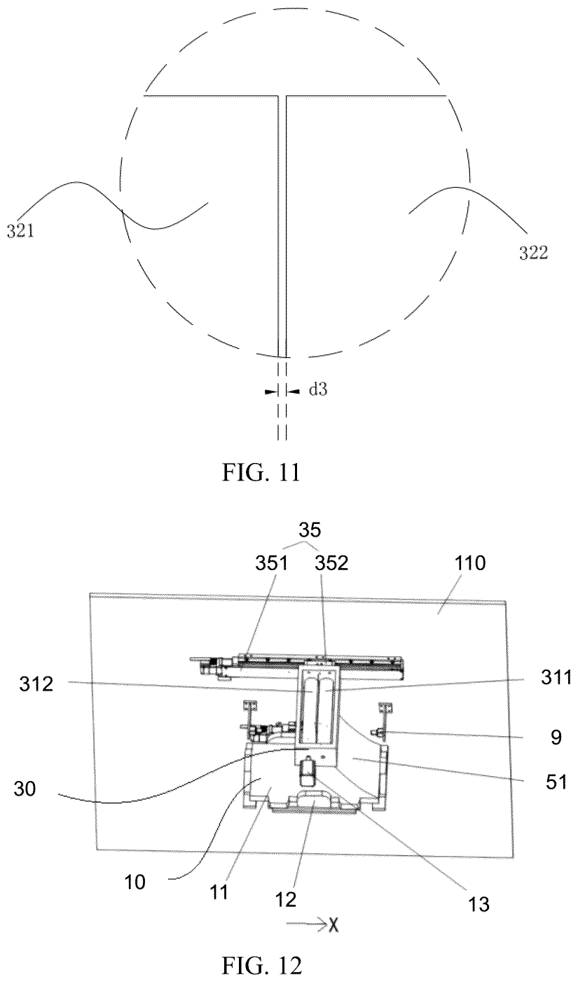

Continuing to refer to FIG. 4 to FIG. 11, the first driving roller assembly 31 includes a first driving roller 311 and a second driving roller 312 arranged opposite to each other, and a second spacing d2 is formed between the first driving roller 311 and the second driving roller 312. The second driving roller assembly 32 is located between the first driving roller assembly 31 and the laminating platform 11. The second driving roller assembly 32 includes a third driving roller 321 and a fourth driving roller 322 arranged opposite to each other, and a third spacing d3 is formed between the third driving roller 321 and the fourth driving roller 322. The first driving roller assembly 31 and the second driving roller assembly 32 are both configured to drive the thermally bonded electrode plate assembly 5 to move, the second spacing d2 and the third spacing d3 are each set to be not greater than a thickness of each of the electrode plate units 51, and/or, the second spacing d2 and the third spacing d3 are each set to be not less than 118 μm, and the second spacing d2 and the third spacing d3 are each set to be not greater than 460 μm.

Each of the electrode plate units 51 which can be thermally bonded through a thermally bonding device usually includes two diaphragms 513, one positive electrode plate 511 and one negative electrode plate 512. The thickness of each of the thermally bonded electrode plate units 51 is set to be a sum of a thickness of two diaphragms 513, a thickness of one positive electrode plate 511 and a thickness of one negative electrode plate 512. A thickness of a single diaphragm 513 is set to be 9 μm-30 μm, the thickness of the positive electrode plate 511 is set to be 50 μm-200 μm, the thickness of the negative electrode plate 512 is set to be 50 μm-200 μm, and the thickness of each of the thermally bonded electrode plate units 51 is set to be 118 μm-460 μm. In an embodiment, the thickness of the spaced area 52 is 24 μm, the thickness of each of the thermally bonded electrode plate units 51 is 344 μm, and the second spacing d2 and the third spacing d3 are each set to be 344 μm, or the second spacing d2 and the third spacing d3 are each set to be 300 μm-344 μm, so that the first driving roller assembly 31 and the second driving roller assembly 32 both can provide sufficient clamping force to the thermally bonded electrode plate units 51.

If the second spacing d2 or the third spacing d3 is outside the above range, the first driving roller assembly 31 and the second driving roller assembly 32 cannot provide suitable clamping effect to the thermally bonded electrode plate units 51, so that the falling and laminating process of the electrode plate assembly is affected. For example, when the second spacing d2 or the third spacing d3 is less than 118 μm, the spacing between the first driving roller assembly 31 and the second driving roller assembly 32 is too small to make the thermally bonded electrode plate units 51 pass through the second spacing d2 or the third spacing d3, resulting in the first driving roller assembly 31 and the second driving roller assembly 32 cannot effectively drive the thermally bonded electrode plate units 51. When the second spacing d2 or the third spacing d3 is greater than 460 μm, the spacing between the first driving roller assembly 31 and the second driving roller assembly 32 is too large to make the first driving roller assembly 31 and the second driving roller assembly 32 provide effective clamping force to the thermally bonded electrode plate units 51.

In some embodiments, based on the thickness of the thermally bonded electrode plate units 51, the second spacing d2 and the third spacing d3 can be adjusted. For example, when the thickness of the thermally bonded electrode plate units 51 that needs to be laminated is set to be 250 μm, the second spacing d2 of the first driving roller assembly 31 and the third spacing d3 of the second driving roller assembly 32 are each adjusted to 250 μm. When the thickness of the thermally bonded electrode plate units 51 that needs to be laminated is set to be 300 μm, the second spacing d2 of the first driving roller assembly 31 and the third spacing d3 of the second driving roller assembly 32 are each adjusted to 300 μm.

The second spacing d2 is configured to be equal to the third spacing d3, so that the thermally bonded electrode plate assembly 5 can pass through the first driving roller assembly 31 and the second driving roller assembly 32 at the same speed, thereby maintaining the stability of the falling and laminating process of the thermally bonded electrode plate assembly 5. For example, when the third spacing d3 is less than the second spacing d2, the drag of the thermally bonded electrode plate assembly 5 when passing through the second driving roller assembly 32 is less than the drag of the thermally bonded electrode plate assembly 5 when passing through the first driving roller assembly 31. Or when the third spacing d3 is significantly larger than the second spacing d2, after the thermally bonded unit passes through the first driving roller assembly 31 along a straight line, and then enters the third spacing d3 of the second driving roller assembly 32, since the third spacing d3 is significantly larger than the second spacing d2, a position offset of the thermally bonded electrode plate units 51 may be occurred in an excessively large spacing, thus affecting the stability of the falling and laminating process.

It should be noted that in addition to the second spacing d2 being exactly equal to the third spacing d3, the second spacing d2 is equal to the third spacing d3 can also be defined as the second spacing d2 is equal to the third spacing d3 within an allowable error range. For example, the second spacing d2 and the third spacing d3 are each set to be 200 μm±5 μm. When the second spacing d2 and the third spacing d3 are each within the range of 200 μm±5 μm, the second spacing d2 can still be considered to be equal to the third spacing d3.

The laminating device 1 further includes a roller driving part 33, which is configured to drive the first driving roller assembly 31 and/or the second driving roller assembly 32. The first driving roller 311 and the third driving roller 321 are configured as driving rollers, the second driving roller 312 and the fourth driving roller 322 are configured as driven rollers, and the roller driving part 33 is configured to be connected only to the driving rollers. An outer surface of the driving rollers is configured to be soft and rough, and an outer surface of the driven rollers is configured to be hard and smooth.

The roller driving part 33 can be configured as one or more of an electric roller driving part, a hydraulic roller driving part, a friction roller driving part, and a gear roller driving part. The first driving roller assembly 31 and the second driving roller assembly 32 can be configured to share a driving device, or the first driving roller assembly 31 and the second driving roller assembly 32 are each configured with a driving device.

One of the first driving roller 311 and the second driving roller 312 is configured as the driving roller, another one of the first driving roller 311 and the second driving roller 312 is configured as the driven roller. One of the third driving roller 321 and the fourth driving roller 322 is configured as the driving roller, another one of the third driving roller 321 and the fourth driving roller 322 is configured as the driven roller.

The driving roller is configured to be connected to the driving device, and the driven roller is connected to the driving roller through a transmission device. The transmission device includes chains, gears, and belts. A rotation speed and a rotation direction of the driven roller are controlled through the driving roller, so that the first driving roller assembly 31 and the second driving roller assembly 32 can operate stably.

Through controlling the driving device to be turned on and turned off, the first driving roller assembly 31 and the second driving roller assembly 32 are controlled to be turned on and turned off. A rotation speed of the first driving roller assembly 31 and the second driving roller assembly 32 is controlled through controlling a power or a rotation speed of the driving device.

Through arranging the outer surface of the driving roller to be soft and rough, and the outer surface of the driven roller to be hard and smooth, the first driving roller assembly 31 and the second driving roller assembly 32 are configured to provide a stable clamping effect to the thermally bonded electrode plate units 51, and the second spacing d2 or the third spacing d3 defined through the driving roller and the driven roller can be adjusted automatically in a small range, thereby preventing the first driving roller assembly 31 and the second driving roller assembly 32 from crushing a surface of the thermally bonded electrode plate units 51.

Specifically, the outer surface of the driving roller is configured to be soft and rough, and the outer surface of the driven roller is configured to be hard and smooth, so that the spacing defined between the driving roller and the driven roller can be adjusted automatically. When the second spacing d2 and the third spacing d3 defined between the driving roller and the driven roller can provide a stable clamping effect to the thermally bonded electrode plate units 51, the spacing can be adjusted automatically based on the thickness of the clamped thermally bonded electrode plate unit 51 itself. For example, when the thickness of the thermally bonded electrode plate unit 51 is set to be 330 μm±5 μm, the second spacing d2 of the first driving roller assembly 31 and the third spacing d3 of the second driving roller assembly 32 are set to be 330 μm. When the thickness of the thermally bonded electrode plate unit 51 passing through the first driving roller assembly 31 is 335 μm, if the spacing defined through the driving roller and the driven roller cannot be adjusted automatically, the thermally bonded electrode plate unit 51 would be compressed by the driving roller and the driven roller, when the thermally bonded electrode plate unit 51 is passing through the second spacing d2 and the third spacing d3, resulting in damage to the outer surface of the thermally bonded electrode plate unit 51.

It should be noted if the outer surfaces of the driving roller and the driven roller are configured to be hard and smooth, the spacing between the driving roller and the driven roller cannot be adjusted automatically.

In some embodiments, a rotation speed of the first driving roller assembly 31 is set to be 1 rpm/min˜40 rpm/min, and the first driving roller assembly 31 can be configured to drive the thermally bonded electrode plate assembly 5 in a movement speed of 1 m/min˜100 m/min. And/or, a rotation speed of the second driving roller assembly 32 is set to be 1 rpm/min˜40 rpm/min, and the second driving roller assembly 32 can be configured to drive the thermally bonded electrode plate assembly 5 in a movement speed of 1 m/min˜100 m/min. And/or, the rotation speed of the first driving roller assembly 31 is set to be equal to the rotation speed of the second driving roller assembly 32.

In some embodiments, the first driving roller 311 and the second driving roller 312 are configured to be cylindrical, as well as the third driving roller 321 and the fourth driving roller 322 are configured to be cylindrical. The external radius of the first driving roller 311, the external radius of the second driving roller 312, the external radius of the third driving roller 321, and the external radius of the fourth driving roller 322 are each set to be 40 mm. The first driving roller 311, the second driving roller 312, the third driving roller 321, and the fourth driving roller 322 are set in the same rotation speed. Taking the first driving roller assembly 31 as an example to illustrate, the rotation speed of the first driving roller assembly 31 is set to be 1 rpm/min˜40 rpm/min, and the first driving roller assembly 31 can be configured to drive the thermally bonded electrode plate assembly 5 in a movement speed of 1 m/min˜100 m/min. It should be noted, the higher the rotation speed of the first driving roller assembly 31, the higher the movement speed of the thermally bonded electrode plate assembly 5 that can be driven by the first driving roller assembly 31. Therefore, the rotation speed of the first driving roller assembly 31 can be set to be any value in the range of 1 rpm/min˜40 rpm/min based on the movement speed of the thermally bonded electrode plate assembly 5 that needs to be driven. Specifically, the rotation speed of the first driving roller assembly 31 can be set to be 5 rpm/min, 10 rpm/min, 15 rpm/min, 20 rpm/min, 25 rpm/min, 30 rpm/min, 35 rpm/min, and a value between any two values or a range between any two values. Correspondingly, the movement speed of the thermally bonded electrode plate assembly 5 that can be driven by the first driving roller assembly 31 can be set to be 10 m/min, 20 m/min, 30 m/min, 40 m/min, 50 m/min, 60 m/min, 70 m/min, 80 m/min, 90 m/min, and a value between any two values or a range between any two values.

Continuing to refer to FIG. 4 to FIG. 6, the laminating device 1 further includes a first support platform 314 and a second support platform 324. The first support platform 314 is configured to fix the first driving roller assembly 31, and the second support platform 324 is configured to fix the second driving roller assembly 32. The first driving roller assembly 31 is configured to be able to move on the first support platform 314, and/or, the second driving roller assembly 32 is configured to be able to move on the second support platform 324.

Through configuring the first driving roller assembly 31 to move from side to side on the first support platform 314, and configuring the second driving roller assembly 32 to move from side to side on the second support platform 324, the thermally bonded electrode plate units 51 can be configured to laminate in a Z-shaped pattern. Specifically, through controlling the first driving roller assembly 31 to move from side to side on the first support platform 314 and the second driving roller assembly 32 to move from side to side on the second support platform 324 at the same speed, the first driving roller assembly 31 and the second driving roller assembly 32 both control the thermally bonded electrode plate assembly 5 to move from side to side at the same speed, so that the thermally bonded electrode plate units 51 are repeatedly laminated on the laminating platform 11 in a Z-shaped pattern.

In some embodiments, a first sliding rail for the first driving roller assembly 31 to move from side to side is arranged on the first support platform 314, and a second sliding rail for the second driving roller assembly 32 to move from side to side is arranged on the second support platform 324.

Continuing to refer to FIG. 4 to FIG. 6, the laminating device 1 further includes a first support frame 313 and a second support frame 323 arranged at intervals. The first driving roller assembly 31 is accommodated inside the first support frame 313, and the second driving roller assembly 32 is accommodated inside the second support frame 323. The first support frame 313 and the second support frame 323 are arranged parallel to each other, the first support frame 313 is arranged approximately perpendicular to the first support platform 314, and the second support frame 323 is arranged approximately perpendicular to the second support platform 324.

A first sliding chute is arranged at a bottom of the first support frame 313. The first chute is arranged to slide from side to side in the first sliding rail. The second sliding chute is arranged at a bottom of the second support frame 323. The second sliding chute is arranged to slide from side to side in the second sliding rail.

Continuing to refer to FIG. 4 to FIG. 6, the laminating device 1 further includes multiple limiting parts 12 arranged on the laminating platform 11, and the multiple limiting parts 12 are arranged to limit position of the thermally bonded electrode plate assembly 5, in which positions of some of the multiple limiting parts 12 are adjustable.

In some embodiments, the multiple limiting parts 12 can be arranged in different directions of the laminating platform 11, such as on the left side, the right side, the front side, and the back side. An area enclosed by the multiple limiting parts 12 is defined as a laminating area of the thermally bonded electrode plates. The laminating area is defined as the position and size of the area when the thermally bonded electrode plate units 51 are laid flat on the laminating platform 11. Through adjusting the positions of some of the limiting parts 12 on the left side, the right side, the front side, and the back side of the laminating platform 11, the size of the laminating area of the thermally bonded electrode plates can be adjusted. For example, based on a size of the battery cell pack formed during preparation, the size of the thermally bonded electrode plate units 51 can be controlled. And through adjusting the positions of some of the limiting parts 12 on the laminating platform 11, the position of the laminating area on the laminating platform 11 can be adjusted.

The first support frame 313, the second support frame 323, and the laminating platform 11 are arranged parallel to each other in sequence, and the laminating platform 11 is configured to move in a direction close to or away from the second support frame 323.

If a lamination size of the thermally bonded electrode plate units 51 is large, the laminating platform 11 can be configured to move in a direction away from the second support frame 323, so that a space between the second support frame 323 and the laminating platform 11 is large enough to allow the thermally bonded electrode plate units 51 to be laminated on the laminating platform 11 in a Z-shaped pattern. If the lamination size of the thermally bonded electrode plate units 51 is small, the laminating platform 11 can be configured to move in a direction close to the second support frame 323, so that the space between the second support frame 323 and the laminating platform 11 is reduced to allow the thermally bonded electrode plate units 5 to be laminated on the laminating platform 11 in a short path, increasing the lamination efficiency.

As shown in FIG. 4 to FIG. 6, the laminating device 1 further includes at least two monitors 9 arranged at intervals, which are configured to monitor the thermally bonded electrode plate assembly 5. The at least two monitors 9 are arranged between the second support platform 324 and the laminating platform 11. At least one of the two monitors 9 is located on one side of the second driving roller assembly 32, and at least one of the two monitors 9 is located on another side of the second driving roller assembly 32.

Two monitors 9 are arranged between the second driving roller assembly 32 and the laminating platform 11, in which the two monitors 9 are located on two sides of the thermally bonded electrode plate units 51, a laminating process of the thermally bonded electrode plate units 51 can be fully monitored, and the alignment of the battery cell pack prepared through the laminating device 1 can be improved.

Embodiments of the present application further provide a processing method for the thermally bonded electrode plate assembly 5. The processing method includes:
forming a thermally bonded electrode plate unit 51 through thermally bonding a positive electrode plate 511, a first diaphragm 5131, a negative electrode plate 512, and a second diaphragm 5132;
driving the first driving roller assembly 31 and the second driving roller assembly 32, in which the thermally bonded electrode plate unit 51 is driven by both the first driving roller assembly 31 and the second driving roller assembly 32 to move towards a direction close to a laminating platform 11, and the thermally bonded electrode plate unit 51 passes through the first driving roller assembly 31 and the second driving roller assembly 32 in sequence; and
laminating multiple electrode plate units 51 through the laminating platform 11 to form a battery cell pack.

The falling and laminating process of the electrode plate assembly 5 are driven and controlled through both the first driving roller assembly 31 and the second driving roller assembly 32, so that the situation where a single driving roller assembly 5 cannot provide effective clamping effect on the spaced areas 52 in the electrode plate assembly 5 and make the falling and laminating process of the electrode plate assembly 5 out of control can be effectively avoided.

The processing method for the thermally bonded electrode plate assembly 5 further includes:
adjusting position of the first driving roller assembly 31 on a first support platform 314, and/or adjusting position of the second driving roller assembly 32 on a second support platform 324, thereby adjusting positions of the electrode plate units 51 relative to the laminating platform 11.

For example, the position of the first driving roller assembly 31 on the first support platform 314 and the position of the second driving roller assembly 32 on the second support platform 324 are synchronously adjusted, the thermally bonded electrode plate assembly 5 can be driven through the first driving roller assembly 31 and the second driving roller assembly 32 to be laminated on the laminating platform 11 in a manner of a Z-shaped lamination.

### Second Embodiment

At present, in the lithium battery industry, in order to ensure the laminating efficiency of the electrode plate units, the laminating device is usually used to laminate the electrode plate units. However, in related art, when the electrode plate units are folded through the laminating device, since the electrode plate units are in a free falling state during a laminating process, and the overall alignment of the multiple electrode plate units laminated cannot be guaranteed only through shaped by shaping cylinders, thus the performance of the electrode plate units and the overall alignment of multiple electrode plate units are affected.

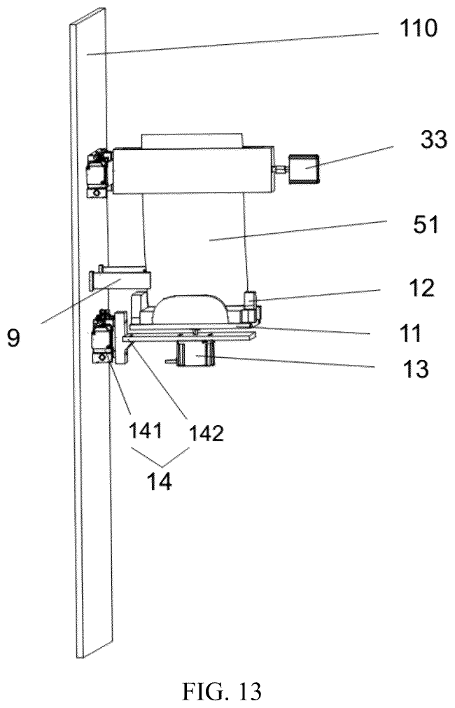

As shown in FIG. 12 and FIG. 13, embodiments of the present application provide an electrode plate laminating device. The electrode plate laminating device includes: a driving mechanism 30, configured to drive multiple thermally bonded electrode plate units 51 to move, where a crease is formed at a connection of two adjacent thermally bonded electrode plate units 51; a receiving assembly 10, arranged below the driving mechanism 30 in a vertical direction. The receiving assembly 10 includes a laminating platform 11 and limiting parts 12. Multiple thermally bonded electrode plate units 51 are bent through creases and laminated on the laminating platform 11. The limiting parts 12 are arranged at an edge of the laminating platform 11 along a circumferential direction of the laminating platform 11, and the limiting parts 12 are configured to limit positions of the thermally bonded electrode plate units 51 in a horizontal direction. The laminating platform 11 can vibrate in the horizontal direction to make the edges of multiple thermally bonded electrode plate units 51 be abutted against and aligned with the limiting parts 12.

In the technical solution of the present application, the receiving assembly 10 is arranged to vibrate in the horizontal direction, and the limiting parts 12 are arranged in a circumferential direction of the laminating platform 11, so that during the operation of the device, the thermally bonded electrode plate units 51 can be in contact with the limiting parts 12 through the vibration of the receiving assembly 10, thus the edges of the thermally bonded electrode plate units 51 can be aligned through the limiting parts 12, ensuring the alignment of the multiple thermally bonded electrode plate units 51.

X direction is a length direction of the side plate 110.

In the present application, the limiting parts 12 are specifically configured as baffles. The baffles are protruding from an end face of the laminating platform 11 in the vertical direction, so that the position of the multiple laminated thermally bonded electrode plate units 51 can be limited, and the overall alignment of multiple thermally bonded electrode plate units 51 can be improved.

Specifically, the receiving assembly 10 further includes a laminating platform driving part 13, which is arranged vertically below the laminating platform 11. A driving end of the laminating platform driving part 13 is connected to the laminating platform 11 in a driving manner to drive the laminating platform 11 to vibrate. In embodiments of the present application, the laminating platform driving part 13 is specifically configured as a driving motor, which is small in size and easy to mount. As such, not only the driving requirements for the device can be met, but also the disassembly and assembly efficiency of the device can be increased, making it convenient for users to maintain and disassemble the laminating platform driving part 13. In addition, in the present application, a structure inside the laminating platform driving part 13 is configured as a cam structure, which can make the laminating platform 11 move along an elliptical trajectory in the horizontal direction, so that the limiting parts 12 can be in contact with the surroundings of the thermally bonded electrode plate units 51, thereby enhancing the correction effect of the device on the alignment of the thermally bonded electrode plate units 51.

Optionally, the laminating platform 11 can also be configured to move along a circumference or a straight line, as long as the usage requirements for the device can be met, which should be selected based on usage environment of the device, so as to improve the applicability and scope of application of the device.

The electrode plate laminating device further includes a laminating platform position adjustment part 14. The laminating platform position adjustment part 14 includes a first mounting part 141 and a first adjusting part 142. The first adjusting part 142 can be movably arranged on the first mounting part 141. The first adjusting part 142 is fixedly connected to the laminating platform driving part 13 and can move in the first direction with the laminating platform driving part 13. With the structure as described above, the positions of the thermally bonded electrode plate units 51 can be adjusted in time during the process of laminating, so that the laminating platform 11 can be adjusted based on positions of the creases to improve the laminating efficiency of the device.

Specifically, the electrode plate laminating device further includes a driving roller position adjusting part 35. The driving roller position adjusting part 35 includes a second mounting part 351 and a second adjusting part 352. The second adjusting part 352 is movably arranged on the second mounting part 351. The second adjusting part 352 is fixedly connected to the driving mechanism 30 and can move along the first direction with the driving mechanism 30. With the structure as described above, the positions of the thermally bonded electrode plate units 51 can be adjusted in time in the process of laminating, so that the driving mechanism 30 can be adjusted based on positions of the creases to cooperate with the laminating platform position adjusting part 14 to increase the laminating efficiency of the device.

In the present application, the laminating platform position adjusting part 14 and the driving roller position adjusting part 35 are both motor-driven screw nut pairs or gear rack pairs, which can not only meet the driving requirements for the device, but also reduce the production cost of the device, so as to realize the batch production of the device.

The driving mechanism 30 includes a first driving roller 311 and a second driving roller 312. The first driving roller 311 and the second driving roller 312 are arranged at intervals along the first direction. The thermally bonded electrode plate units 51 are arranged to pass through a gap between the first driving roller 311 and the second driving roller 312. The first driving roller 311 and the second driving roller 312 are rotated to drive the thermally bonded electrode plate units 51 to move. As such, not only power for the thermally bonded electrode plate units 51 is provided, but also the movement of the thermally bonded electrode plate units 51 is guided, so that the movement efficiency of the thermally bonded electrode plate units 51 is increased, and it can also ensure that the thermally bonded electrode plate units 51 would not be offset during the movement, thus improving the stability of the thermally bonded electrode plate units 51 during folding.

A rotation direction of the first driving roller 311 is opposite to a rotation direction of the second driving roller 312. As such, the first driving roller 311 and the second driving roller 312 can apply a tension to a surface of the thermally bonded electrode plate units 51, so that a tension balance in all directions of the thermally bonded electrode plate units 51 can be realized, and an uneven surface of the thermally bonded electrode plate units 51 can be avoided, preventing wrinkles on the surface of the thermally bonded electrode plate units 51.

The driving mechanism 30 further includes a roller driving part 33, a driving end of the roller driving part 33 is in drive connection to one of the first driving roller 311 and the second driving roller 312, and the first driving roller 311 is in transmission connection to the second driving roller 312 to rotate simultaneously. In the present application, the roller driving part 33 is specifically configured as a drive motor. The structure as described above is small in size and easy to install, so that not only the driving requirements for the device can be met, but also the disassembly and assembly efficiency of the device can be increased, making it convenient for users to maintain and disassemble the roller driving part 33.

Specifically, the electrode plate laminating device further includes a monitor 9. In this embodiment, the monitor 9 is configured as a visual camera. The monitor 9 is arranged between the driving mechanism 30 and the receiving assembly 10 in the vertical direction. The monitor 9 is configured to monitor positions of the thermally bonded electrode plate units 51, and the monitor 9 is in communication connection with both the laminating platform position adjustment part 14 and the driving roller position adjusting part 35. The laminating platform position adjustment part 14 and the driving roller position adjusting part 35 can receive signal from the monitor 9 to adjust positions of the thermally bonded electrode plate units 51. As such, in case that the position of the thermally bonded electrode plate units 51 is offset, the position of the thermally bonded electrode plate units 51 can be adjusted in time through the laminating platform position adjusting part 14 and the driving roller position adjusting part 35, so that the production line can be corrected when feeding the thermally bonded electrode plate units 51, and improve the alignment of the thermally bonded electrode plate units 51 laminated.

There are two monitors 9, and the two monitors 9 are arranged opposite to each other on two sides of the thermally bonded electrode plate units 51 along the horizontal direction. As such, the monitoring accuracy of the monitors 9 can be improved, thereby improving the alignment of the thermally bonded electrode plate units 51 laminated.

Specifically, the electrode plate laminating device further includes a side plate 110, and the laminating platform position adjustment part 14 and the driving roller position adjusting part 35 are both fixed on the side plate 110. As such, the overall integration of the device is improved, which is conducive to the disassembly and maintenance of each assembly, thereby increasing the disassembly efficiency and maintenance efficiency of the device.

In the technical solution of the present application, the receiving assembly 10 is configured to vibrate in the horizontal direction, and the limiting parts 12 are arranged in the circumferential direction of the laminating platform 11. As such, during the operation of the device, the thermally bonded electrode plate units 51 can be in contact with the limiting parts 12 through the vibration of the receiving assembly 10, thus the edges of the thermally bonded electrode plate units 51 can be aligned through the limiting parts 12, ensuring the alignment of the multiple thermally bonded electrode plate units 51, and also increasing the laminating efficiency of the device.

It should be noted that the terms used here is only to describe some embodiments, not to limit embodiments based on the present application. As used here, the singular form is also intended to include the plural form unless explicitly stated in the context. In addition, it should be noted that when the terms “contain” and/or “include” are used in this specification, the terms indicate the presence of features, steps, operations, devices, assemblies and/or combinations of them.

Unless otherwise specified, the opposite arrangement, numerical expressions and values of the parts and steps described in these embodiments do not limit the scope of the present application. Simultaneously, it should be noted that in order to facilitate the description, the size of each part shown in the accompanying drawings is not drawn based on the actual proportional relationship. The technologies, methods and devices known to the general technical personnel in the related field may not be discussed in detail, but in appropriate cases, the technologies, methods and device should be considered as part of the authorization specification. In all embodiments shown and discussed here, any specific value should be interpreted as merely illustrative, but not as a restriction. Therefore, other examples of exemplary embodiments can have different values. It should be noted that similar numerals and letters represent similar items in the accompanying drawings. Therefore, once an item is defined in an accompanying drawing, it does not need to be discussed in the subsequent drawings. In the description of the present application, it should be noted that the orientation or positional relationship indicated by orientation words such as “front, rear, upper, lower, left, right”, “horizontal, vertical, vertical, horizontal” and “top, bottom” is usually based on the orientation or positional relationship shown in the accompanying drawings, which is only for the convenience of describing the present application and simplifying the description. In the absence of the opposite explanation, these orientation words do not indicate and imply that the device or element referred to must have a specific orientation or be constructed and operated in a specific orientation, so they cannot be understood as a restriction on the scope of protection of the present application. The location words “inside and outside” refer to the inside and outside of the contour relative to each part itself.

For convenience for description, spatial relative terms can be used here, such as “on . . . ”, “above . . . ”, “on an upper surface of . . . ”, “upper”, etc. are used to describe the spatial position relationship between a device or feature and other devices or features as shown in the drawings. It should be noted that the spatial relative terms are intended to contain different orientations in use or operation in addition to the orientations of the device described in the drawings. For example, if the device in the drawings is inverted, the device described as “on other devices or structures” or “above other devices or structures” would be defined as “under other devices or structures” or “below other devices or structures”. Thus, the exemplar term “on . . . ” can include two directions of “on . . . ” and “under . . . ”. The device can also be positioned in other different manners (rotating 90 degrees or in other directions), and the spatial relative description used here is explained accordingly.

In addition, it should be noted that the use of “first”, “second” and other words to limiting parts is only to facilitate the distinction between the corresponding parts. If there is no separate statement, the above words have no special meaning, so they cannot be understood as restrictions on the scope of protection of the present application.

### Third Embodiment

The electrode plate assembly in the battery cell are usually formed by laminating the positive electrode plates, the diaphragms, and the negative electrode plates through the thermally bonding lamination process. The thermally bonded electrode plate assembly includes multiple thermally bonded electrode plate units connected to each other. Two adjacent thermally bonded electrode plate units are connected through a spaced section. The spaced section usually includes two diaphragms. Each thermally bonded electrode plate unit includes a negative electrode plate, a first diaphragm, a positive electrode plate, and a second diaphragm laminated in sequence.

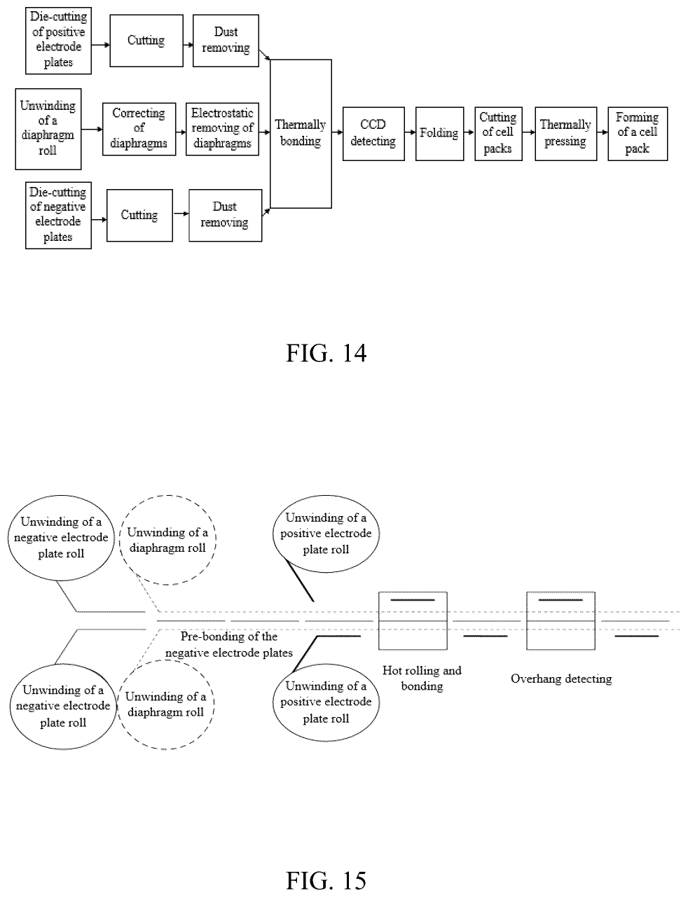

As shown in FIG. 14 and FIG. 15, the thermally bonding lamination process in the battery includes:
providing negative electrode plates, diaphragms, and positive electrode plates;
forming a thermally bonded electrode plate unit by one negative electrode plate, two diaphragms and one positive electrode plate through thermally bonding and rolling process, in which two adjacent thermally bonded electrode plate units are connected through a spaced section, and multiple thermally bonded electrode plate units are connected to form a thermally bonded electrode plate assembly;
detecting the thermally bonded electrode plate units through a photon detector (CCD) to detect alignment of the positive electrode plates and the negative electrode plates in each thermally bonded electrode plate unit;
laminating multiple thermally bonded electrode plate units through a laminating device to form an electrode plate assembly in a battery cell;
cutting off a spaced section between the electrode plate assemblies in two adjacent battery cells; and
thermally pressing the electrode plate assembly in the battery cell to form a battery cell pack.

The negative electrode plates are formed by continuously unwinding a roll of negative electrode plate and providing it on the operating platform, then performing cutting and dust removal on the operating platform to form the negative electrode plates with a certain specification. The diaphragms are formed by continuously unwinding a roll of diaphragm and providing it to the operating platform, then performing position correction and electrostatic removal on the operating platform. Unwinding of the diaphragm is performed after unwinding of the negative electrode. The positive electrode plates are formed by continuously unwinding a roll of positive electrode plate and providing it on the operating platform, then performing cutting and dust removal on the operating platform to form the positive electrode plates with a certain specification. Unwinding of the positive electrode plate is performed after unwinding of the diaphragm. The spaced section between the thermally bonded electrode plate units includes two diaphragms.

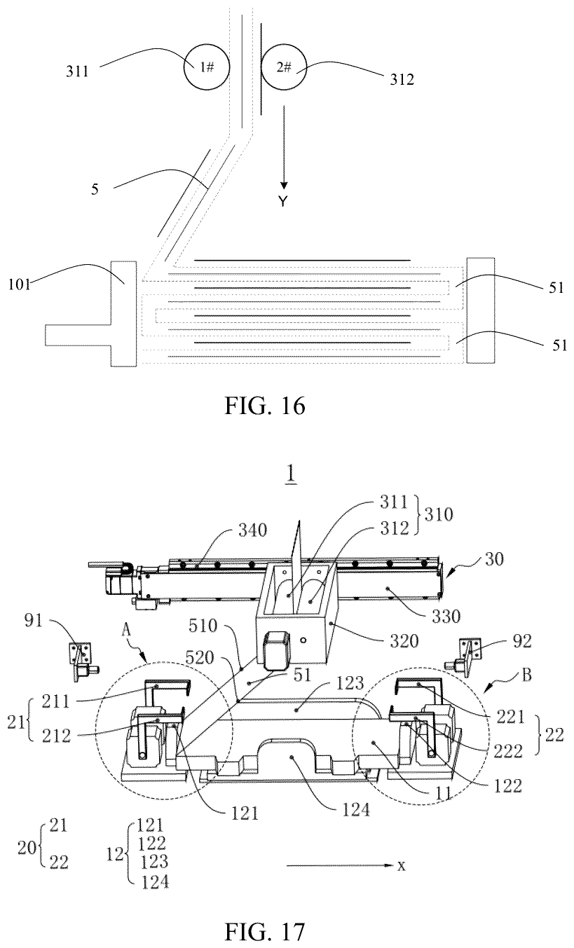

As shown in FIG. 16, during the laminating process of the thermally bonded electrode plate assembly 5, the thermally bonded electrode plate assembly 5 is configured to be driven through a driving mechanism. The driving mechanism includes a first driving roller 311 and a second driving roller 312. The thermally bonded electrode plate assembly 5 is clamped between the first driving roller 311 and the second driving roller 312. In the process of being provided to the laminating platform through the driving mechanism, the thermally bonded electrode plate assembly 5 is in a free falling state, as indicated by an arrow Y in FIG. 16. Since the thermally bonded electrode plate assembly 5 is in a free falling state during the falling and laminating process, the thermally bonded electrode plate assembly 5 is shaped only through shaping cylinders 101 arranged on two sides of the laminating platform, resulting in poor overall alignment of the electrode plate assembly in a single battery cell, and the alignment is only ±1.0 mm. The thermally bonding lamination process in the related art is only suitable for the thermally bonded electrode plate assembly with a width of an electrode plate not greater than 150 mm. In case that a width of an electrode plate is greater than 340 mm, the electrode plate assembly would arch upward during the laminating process, resulting in poorer overall alignment of the electrode plate assembly in a formed single battery cell, which cannot be applied in the industry.

In the process of shaping the thermally bonded electrode plate assembly 5 through the shaping cylinders 101 arranged on two sides of the laminating platform 11, the thermally bonded electrode plate assembly 5 are hit by the shaping cylinders 101, which would cause an active material on the positive electrode plates or the negative electrode plates to fall off due to hitting, thus leading to the risk of short circuit inside the battery cell.

A spacing between two adjacent thermally bonded electrode plates 51 is 1 mm±0.3 mm, and the accuracy of the spaced section itself is poor, so that a crease between two adjacent battery cells is not arranged in a middle of the spacing of the spaced section during folding process of the thermally bonded electrode plate assembly 5 in a Z-shaped pattern.

In view of the poor overall alignment of the electrode plate assembly in the battery cell formed through the thermally bonding lamination process in the related art, and it is only applicable to the thermally bonded electrode plate assembly in which the width of the thermally bonded electrode plate unit is not greater than 150 mm, embodiments of the present application improve the structure of the laminating device.

Referring to FIG. 17 to FIG. 19, the present application provides a laminating device 1 comprising a laminating platform 11 and at least one pressing mechanism 20.

The laminating platform 11 is configured for laminating the thermally bonded electrode plate assembly 5. A limiting part 12 is arranged on each side of the laminating platform 11, and a laminating area of the thermally bonded electrode plate assembly 5 is defined through multiple limiting parts 12. The limiting parts 12 are configured to be adjustable. Through adjusting position of the limiting parts 12, size of an area, on the laminating platform 11, for laminating the thermally bonded electrode plate assembly 5 can be adjusted.

The pressing mechanism 20 includes a first pressing mechanism 21 arranged on a first side 151 of the laminating platform 11. The first pressing mechanism 21 includes a first pressing device 211 and a second pressing device 212. A spacing between the first pressing device 211 and the second pressing device 212 is equal to a width w of the thermally bonded electrode plate unit 51. The first pressing device 211 is pressed on one side 510 of the thermally bonded electrode plate unit 51, and the second pressing device 212 is pressed on another side 520 of the thermally bonded electrode plate unit 51. A spacing between the one side 510 of the thermally bonded electrode plate unit 51 and the another side 520 of the thermally bonded electrode plate unit is set to be equal to the width w of the thermally bonded electrode plate unit 51.

The pressing mechanism is used to replace the shaping cylinders in the related art, in the laminating process of the thermally bonded electrode plate assembly 5, two sides, in a width direction, of the thermally bonded electrode plate assembly 5 are pressed through the first pressing device 211 and the second pressing device 212, so that a pressing tension is applied to the thermally bonded electrode plate assembly in the process of movement of the thermally bonded electrode plate assembly 5 from the driving mechanism to the laminating platform 11, which helps to improve the overall alignment of the electrode plate assembly in the battery cell.

Through research, the inventor found that the alignment of the electrode plate assembly in the battery cell formed by laminating the thermally bonded electrode plate units through the laminating device in the related art is only ±1.0 mm, while the alignment of the electrode plate assembly in the battery cell formed by laminating the thermally bonded electrode plate units through the laminating device 1 provided in the present application can be increased to ±0.05 mm, and the alignment accuracy of the electrode plate assembly in the battery cell can be increased by 100%, which is crucial for improving the performance of the battery cell.

A spacing d between the first pressing device 211 and the second pressing device 212 is set to be 100 mm˜600 mm. The spacing d between the first pressing device 211 and the second pressing device 212 can be set to be 100 mm, 150 mm, 200 mm, 250 mm, 300 mm, 350 mm, 400 mm, 450 mm, 500 mm, 600 mm and a value between any two of the above values or a range between any two of the above values.

The spacing d between the first pressing device 211 and the second pressing device 212 is adjusted based on the width of the thermally bonded electrode plate unit 51. In case that the width of the thermally bonded electrode plate unit 51 is set to be 150 mm, the spacing d between the first pressing device 211 and the second pressing device 212 is correspondingly set to be 150 mm. In case that the width of the thermally bonded electrode plate unit 51 is set to be 340 mm, the spacing d between the first pressing device 211 and the second pressing device 212 is correspondingly set to be 340 mm.

In some embodiments, the spacing between the first pressing device 211 and the second pressing device 212 is adjustable, that is, the first pressing mechanism 21 further includes an adjusting part. The adjusting part adjusts the spacing between the first pressing device 211 and the second pressing device 212 based on the width of the thermally bonded electrode plate assembly 5, so that the laminating device can be compatible with the laminating requirements for the thermally bonded electrode plate assembly 5 of different sizes. The present application does not exclude that in a same laminating device, the spacing between the first pressing device 211 and the second pressing device 212 is set to be a certain value, and in different laminating devices, the spacing between the first pressing device 211 and the second pressing device 212 is set to be different.

Since two sides of the thermally bonded electrode plate assembly 5 are pressed through the first pressing device 211 and the second pressing device 212 during the process of movement of the thermally bonded electrode plate assembly 5 from the driving mechanism 30 to the laminating platform 11, even if the width w of the thermally bonded electrode plate unit 51 is large, for example, in case that the width w of the thermally bonded electrode plate unit 51 is greater than 340 mm, the thermally bonded electrode plate assembly 5 is in a state of tension tightening, which can effectively improve the situation where the thermally bonded electrode plate assembly 5 forms an upward micro-arch structure in the process of falling and laminating, so that a good alignment can be maintained for a wide thermally bonded electrode plate assembly 5 when laminating through the laminating device 1 provided in embodiments of the present application. Through research, the inventor found that the alignment of the electrode plate assembly in the battery cell formed by laminating the wide thermally bonded electrode plate assembly 5 through the laminating device provided in embodiments of the present application can still be maintained at ±1.0 mm, thereby significantly improving a width range of the thermally bonded electrode plate assembly 5 compatible with the laminating device 1.

Continuing to refer to FIG. 17 to FIG. 19, the pressing mechanism 20 further includes a second pressing mechanism 22 arranged opposite to the first pressing mechanism 21. The second pressing mechanism 22 includes a third pressing device 221 and a fourth pressing device 222. The spacing d between the third pressing device 221 and the fourth pressing device 222 is also equal to the width of the thermally bonded electrode plate unit 51. The first pressing mechanism 21 is arranged on a first side 151 of the laminating platform 11, and the second pressing mechanism 22 is arranged on a second side 152 of the laminating platform 11. In case that the thermally bonded electrode plate unit 51 is located on the first side 151 of the laminating platform 11, the first pressing mechanism 21 provides a constant pressing tension for thermally bonded electrode plate unit 51. In case that the thermally bonded electrode plate unit 51 is located on the first side 151 of the laminating platform 11, the first pressing mechanism 21 provides a constant pressing tension for the thermally bonded electrode plate unit 51. In case that the thermally bonded electrode plate unit 51 is located on the second side 152 of the laminating platform 11, the second pressing mechanism 22 provides a constant pressing tension for the thermally bonded electrode plate unit 51, thereby facilitating laminating of the thermally bonded electrode plate assembly 5 in a Z-shaped pattern on the laminating platform 11.

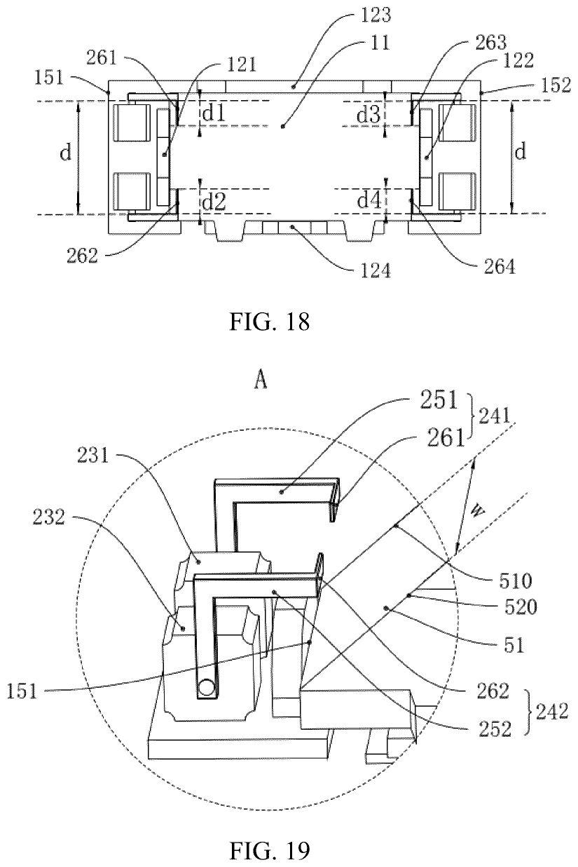

The first pressing mechanism 21 and the second pressing mechanism 22 are of the same structure and are arranged completely symmetrical to each other. As shown in FIG. 18, the first pressing device 211 is arranged directly opposite to the third pressing device 221, and the second pressing device 212 is arranged directly opposite to the fourth pressing device 222.

Continuing to refer to FIG. 17 to FIG. 19, the first pressing device 211, the second pressing device 212, the third pressing device 221, and the fourth pressing device 222 each include a driving part and a pressing part. The pressing part includes a connecting portion connected to the driving part, and a pressing part bent and connected to the connecting portion. The driving part 23 is configured to drive the pressing part to move towards a direction close to or away from the laminating platform 11. The pressing part is configured to press the thermally bonded electrode plate unit 51, and an extension direction of the pressing part is configured to be the same as the width direction of the thermally bonded electrode plate unit 51.

As shown in FIG. 17 and FIG. 19, the first pressing device 211 includes a first driving part 231 and a first pressing part 241. The first pressing part 241 includes a first connecting portion 251, and a first pressing portion 261 bent and connected to the first connecting portion 251. The second pressing device 212 includes a second driving part 232 and a second pressing part 242. The second pressing part 242 includes a second connecting portion 252, and a second pressing portion 262 bent and connected to the second connecting portion 252. The first pressing portion 261 and the second pressing portion 262 both extend along a width direction of the thermally bonded electrode plate assembly 5, and an extension direction of the first pressing portion 261 is opposite to an extension direction of the second pressing portion 262. In case that the thermally bonded electrode plate assembly 5 is located on the first side 151 of the laminating platform 11, the first pressing portion 261 is pressed on the one side 510 of the thermally bonded electrode plate assembly, and the second pressing portion 262 is pressed on the another side 520 of the thermally bonded electrode plate unit 51.

In case that the thermally bonded electrode plate assembly 5 is located on the first side 151 of the laminating platform 11, through arranging the first pressing portion 261 and the second pressing portion 262 opposite to each other, the first pressing portion 261 and the second pressing portion 262 are both pressed on the thermally bonded electrode plate assembly 5. A sum of contact areas between the first pressing portion 261 and the second pressing portion 262 with the thermally bonded electrode plate assembly 5 is configured as a contact area of the first pressing mechanism 21 with the thermally bonded electrode plate assembly 5. The first connecting portion 251 and the second connecting portion 252 are configured to be not in contact with the thermally bonded electrode plate assembly 5. The first pressing portion 261 and the second pressing portion 262 are configured to extend along a width direction of the thermally bonded electrode plate assembly 5, so that the first pressing device 211 and the second pressing device 212 can provide a pressing force along the width direction of the thermally bonded electrode plate assembly 5. The pressing force is perpendicular to a laminating direction of the thermally bonded electrode plate assembly 5, so that the thermally bonded electrode plate assembly 5 can be adhered to the laminating platform 11 as much as possible.

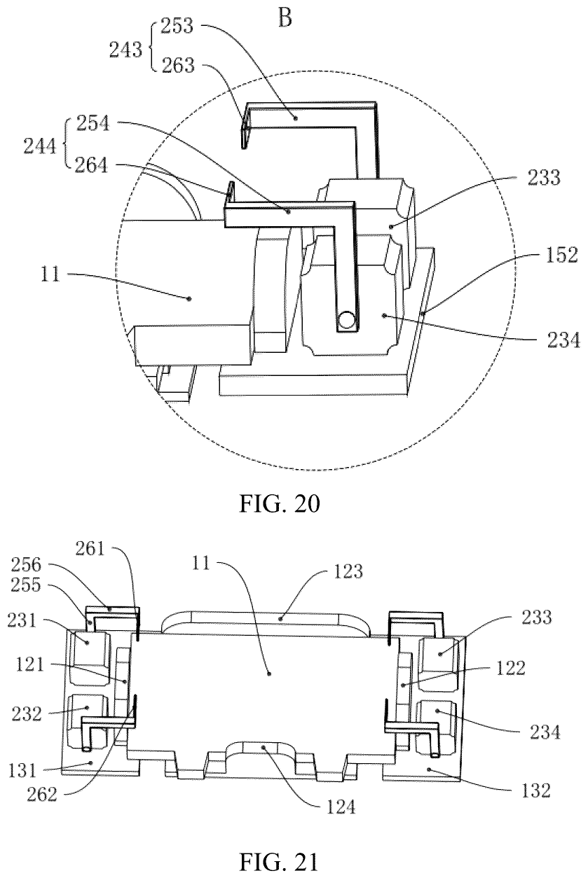

As shown in FIG. 17 and FIG. 20, the third pressing device 221 includes a third driving part 233 and a third pressing part 243. The third pressing part 243 includes a third connecting portion 253, and a third pressing portion 263 bent and connected to the third connecting portion 253. The fourth pressing device 222 includes a fourth driving part 234 and a fourth pressing part 244. The fourth pressing part 244 includes a fourth connecting portion 254, and a fourth pressing portion 264 bent and connected to the fourth connecting portion 254. The third pressing portion 263 and the fourth pressing portion 264 both extend along a width direction of the thermally bonded electrode plate assembly 5, and an extension direction of the third pressing portion 263 is opposite to an extension direction of the fourth pressing portion 264. In case that the thermally bonded electrode plate assembly 5 is located on a second side of the laminating platform 11, the third pressing portion 263 is pressed on one side of the thermally bonded electrode plate assembly 5, and the fourth pressing portion 264 is pressed on another side of the thermally bonded electrode plate assembly 5.

In case that the thermally bonded electrode plate assembly 5 is located on the second side of the laminating platform 11, through arranging the third pressing portion 263 and the fourth pressing portion 264 opposite to each other, the third pressing portion 263 and the fourth pressing portion 264 are both pressed on the thermally bonded electrode plate assembly 5. A sum of contact areas between the third pressing portion 263 and the fourth pressing portion 264 with the thermally bonded electrode plate assembly 5 is configured as a contact area of the first pressing mechanism 21 with the thermally bonded electrode plate assembly 5. The third connecting portion 253 and the fourth connecting portion 254 are configured to be not in contact with the thermally bonded electrode plate assembly 5. The third pressing portion 263 and the fourth pressing portion 264 are configured to extend along a width direction of the thermally bonded electrode plate assembly 5, so that the third pressing device 221 and the fourth pressing device 222 can provide a pressing force along the width direction of the thermally bonded electrode plate assembly 5. The pressing force is perpendicular to a laminating direction of the thermally bonded electrode plate assembly 5, so that the thermally bonded electrode plate assembly 5 can be adhered to the laminating platform 11 as much as possible.

Continuing to refer to FIG. 18, a length of the first pressing portion 261 extending along the width direction of the thermally bonded electrode plate unit is d1, and a length of the second pressing portion 262 extending along the width direction of the thermally bonded electrode plate unit is d2. A ratio of the sum of the length dl of the first pressing portion 261 and the length d2 of the second pressing portion 262 to the width w of the thermally bonded electrode plate unit, that is, (d1+d2)/w, satisfies: (1/40˜1/30):1. The first pressing portion 261 and the second pressing portion 262 are configured in symmetrical arrangement.

The first pressing device 211 contacts with the thermally bonded electrode plate unit through the first pressing portion 261, and the second pressing device 212 contacts with the thermally bonded electrode plate unit through the second pressing portion 262. Through research, the inventor found that the ratio of the sum of the length d1 of the first pressing portion 261 and the length d2 of the second pressing portion 262 to the width w of the thermally bonded electrode plate unit, that is, (d1+d2)/w, satisfies: (1/40˜1/30):1. In case that the ratio of (d1+d2)/w is less than 1/40, the pressing force provided to the thermally bonded electrode plate unit 51 through the first pressing portion 261 and the second pressing portion 262 is insufficient, so that the alignment of the electrode plate assembly in the battery cell formed through laminating cannot meet the requirements. In case that the ratio of (d1+d2)/w is greater than 1/30, imprints would be formed on the thermally bonded electrode plate assembly when pressed by the first pressing portion 261 and the second pressing portion 262, so that the performance of the thermally bonded electrode plate assembly would be affected.

Correspondingly, a length of the third pressing portion 263 extending along the width direction of the thermally bonded electrode plate units is d3, and a length of the fourth pressing portion 264 extending along the width direction of the thermally bonded electrode plate units is d4. A ratio of a sum of the length d3 of the third pressing portion 263 and the length d4 of the fourth pressing portion 264 to the width w of the thermally bonded electrode plate unit, that is, (d3+d4)/w, satisfies: (1/40˜1/30):1. The third pressing portion 263 and the fourth pressing portion 264 are configured in symmetrical arrangement.

The third pressing device 221 is in contact with the thermally bonded electrode plate unit through the third pressing portion 263, and the fourth pressing device 222 is in contact with the thermally bonded electrode plate unit through the fourth pressing portion 264. Through research, the inventor found that the ratio of the sum of the length d3 of the third pressing portion 263 and the length d4 of the fourth pressing portion 264 to the width w of the thermally bonded electrode plate unit, that is, (d3+d4)/w, satisfies: (1/40˜1/30):1. In case that the ratio of (d3+d4)/w is less than 1/40, a pressing force provided to the thermally bonded electrode plate units 51 through the third pressing portion 263 and the fourth pressing portion 264 is insufficient, so that the alignment of the electrode plate assembly in the battery cell formed through laminating cannot meet the requirements. In case that the ratio of (d3+d4)/w is greater than 1/30, imprints would be formed on the thermally bonded electrode plate assembly when pressed by the first pressing portion 261 and the second pressing portion 262, so that the performance of the thermally bonded electrode plate assembly would be affected.

Referring to FIG. 17 and FIG. 21, the connecting portion of each pressing device includes a first connecting section 255, and a second connecting section 256 bent and connected to the first connecting section 255. An end, facing away from the second connecting section 256, of the first connecting section 255 is connected to the driving part, and an end, facing away from the first connecting section 255, of the second connecting section 256 is connected to the pressing part. The driving part is configured to be drive the pressing device to move in a direction perpendicular to the laminating platform 11.

In case that the thermally bonded electrode plate assembly 5 is located on the first side 151 of the laminating platform 11, the first pressing mechanism 21 is pressed on the thermally bonded electrode plate assembly 5, and the second pressing mechanism 22 is configured to be in a lifting state, that is, the second pressing mechanism is in a non-contact state with the thermally bonded electrode plate assembly 5. In case that the thermally bonded electrode plate assembly 5 is located on the second side of the laminating platform 11, the second pressing mechanism 22 is pressed on the thermally bonded electrode plate assembly 5, and the first pressing mechanism 21 is in a lifting state, that is, the second pressing mechanism is in a non-contact state with the thermally bonded electrode plate assembly 5.

Based on position of the thermally bonded electrode plate assembly 5, the first pressing mechanism 21 and the second pressing mechanism 22 are in a pressing state and a lifting state, and the driving part is configured to control a corresponding pressing device to change from the pressing state to the lifting state. It should be noted that the first pressing device 211 is synchronized with the second pressing device 212, and the third pressing device 221 is synchronized with the fourth pressing device 222. Therefore, a driving state of the first pressing device 211 by the first driving part 231 is synchronized with a driving state of the second pressing device 212 by the second driving part 232. A driving state of the third pressing device 221 by the third driving part 233 is synchronized with a driving state of the fourth pressing device 222 by the fourth driving part 234.

The first pressing device 211 and the second pressing device 212 are configured to be synchronously in the pressing state and the lifting state. Correspondingly, the third pressing device 221 and the fourth pressing device 222 are configured to be synchronously in the lifting state and the pressing state. Specifically, in case that the thermally bonded electrode plate assembly 5 is on the first side of the laminating platform 151, the first pressing device 211 and the second pressing device 212 are synchronously in the pressing state, and the third pressing device 221 and the fourth pressing device 222 are synchronously in the lifting state. In case that the thermally bonded electrode plate assembly 5 is on the second side of the laminating platform, the first pressing device 211 and the second pressing device 212 are synchronously in the lifting state, and the third pressing device 221 and the fourth pressing device 222 are synchronously in the pressing state.

In order to increase movement speed of the pressing device, the pressing part is configured to move along a direction perpendicular to the laminating platform. Taking the first pressing device 211 as an example, in case that the first pressing device 211 changes from the lifting state to the pressing state, the first pressing portion 261 is configured to move downwards in a direction perpendicular to the laminating platform. In case that the first pressing device 211 changes from the pressing state to the lifting state, the first pressing portion 261 is configured to move upwards in a direction perpendicular to the laminating platform. Therefore, the second connecting section 256 connected to the first pressing portion 261 is configured to be extend along a direction parallel to a side of the laminating platform. The first connecting section 255 is configured to be extend in a direction perpendicular to the second connecting section 256.

The driving part can be configured as a movable cylinder that can move upwards and downwards in a direction perpendicular to the laminating platform, so that the pressing device can be quickly adjusted based on position of the thermally bonded electrode plate assembly 5.

Continuing to refer to FIG. 17, FIG. 19, and FIG. 20, the laminating device 1 further includes a first support part 131 and a second support part 132. The first pressing mechanism 21 is mounted on the first support part 131, and the second pressing mechanism 22 is mounted on the second support part 132. The first support part 131 is connected to the first side 151 of the laminating platform 11, and the second support part 132 is connected to the second side of the laminating platform 11.

Referring to FIG. 17, FIG. 18, and FIG. 21, a first baffle 121 is arranged on the first side 151 of the laminating platform 11, a second baffle 122 is arranged on the second side 152 of the laminating platform 11, a third baffle 123 is arranged on a third side of the laminating platform 11, and a fourth baffle 124 is arranged on a fourth side of the laminating platform 11. The first side 151 and the second side 152 are arranged opposite to each other, as well as the third side and the fourth side are arranged opposite to each other. The first pressing mechanism 21 is located on a side of the first baffle 121, and the second pressing mechanism 22 is located on a side of the second baffle 122. A length of the first baffle 121 extending along a first side of the laminating platform 11 is less than a spacing between the first pressing device 211 and the second pressing device 212, so that the interference between the first baffle 121 and the first connecting portion 251 or the second connecting portion 252, which affects the first pressing device 211 and the second pressing device 212 to move upwards and downwards in the direction perpendicular to the laminating platform 11, is avoided. Correspondingly, a length of the second baffle 122 extending along the first side of the laminating platform 11 is less than a spacing between the third pressing device 221 and the fourth pressing device 222, so that the interference between the second baffle 122 and the third connecting portion 253 or the fourth connecting portion 254, which affects the third pressing device 221 and the fourth pressing device 222 to move upwards and downwards in the direction perpendicular to the laminating platform 11, is avoided.

Continuing to refer to FIG. 17, the laminating device further includes a driving mechanism 30, and the driving mechanism 30 includes a driving roller assembly 310, a support frame 320, and a support base 330.

The driving roller assembly 310 includes a first driving roller 311 and a second driving roller 312. The first driving roller 311 and the second driving roller 312 are both configured as a cylindrical structure. During the falling and laminating process of the thermally bonded electrode plate assembly 5, the thermally bonded electrode plate assembly 5 is clamped between the first driving roller 311 and the second driving roller 312.

The support frame 320 includes a hollow accommodation chamber. The first driving roller 311 and the second driving roller 312 are accommodated in the accommodation chamber of the support frame 320.

A bottom of the support frame 320 is fixed on the support base 330, and the support base 320 is configured to slide from side to side on the support base 330. Specifically, a first guide rail 340 is arranged on the support base 330, and a sliding part that can slide on the first guide rail 340 is arranged on the bottom of the support frame 320.

In order to increase the laminating efficiency of the laminating device 1, the laminating platform 11 and the driving roller assembly 310 are configured to move towards each other. In the related art, in the process of laminating the thermally bonded electrode plate assembly 5 in a Z-shaped pattern, the driving roller assembly 310 is configured to move back and forth along the first guide rail 340 on the support base 330, and the laminating platform 11 is in a static state. In embodiments of the present application, the laminating platform 11 and the driving roller assembly 310 are configured to move towards each other. Taking the thermally bonded electrode plate assembly 5 moving from the first side 151 to the second side of the laminating platform 11 as an example, the driving roller assembly 310 moves along the first guide rail 340 on the support base 330 in the X direction as shown in FIG. 17. Correspondingly, the laminating platform 11 moves along the second guide rail in a direction opposite to the Y direction, so that the laminating efficiency can be effectively increased.

In the related art, the laminating efficiency of the laminating device is 0.6 s/piece. Through research, the inventor found in case that the laminating platform 11 is configured to move towards the driving roller assembly 310, the lamination efficiency of the laminating device 1 provided in embodiments of the present application can be 0.1 s/piece˜0.3 s/piece, and the laminating efficiency is increased by at least 100%. In some embodiments, the laminating efficiency of laminating device 1 can be 0.1 s/piece, 0.2 s/piece, 0.3 s/piece, and a value between any two of the above values, or a range between any two of the above values.

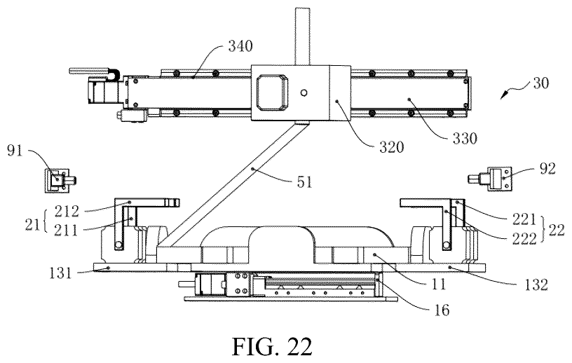

Referring to FIG. 17 and FIG. 22, a second guide rail 16 is arranged at a bottom of the laminating platform 11, and the laminating platform 11 is configured to slide along the second guide rail 16. The second guide rail 16 is located between the first pressing mechanism 21 and the second pressing mechanism 22.

When the driving roller assembly 310 drives the thermally bonded electrode plate assembly 5 along the first guide rail 340 from the first side 151 of the laminating platform 11 towards a second side of the laminating platform 11, the laminating platform 11 is configured to move in an opposite direction along the second guide rail 16. In some embodiments, an extension length of the first guide rail 340 is greater than an extension length of the second guide rail 16. Since the driving roller assembly 310 is configured to drive the thermally bonded electrode plate assembly 5 to move, the thermally bonded electrode plate assembly 5 is configured to move from the first side 151 of the laminating platform 11 to the second side of the laminating platform 11, the length of the first guide rail 340 is set to be greater than the length of the laminating platform 11, and the second guide rail 16 is configured for the movement of the laminating platform 11. As shown in FIG. 22, The second guide rail 16 is located at the bottom of the laminating platform 11, and a length of the second guide rail 16 is less than the length of the laminating platform 11, so that the length of the first guide rail 340 is greater than the length of the second guide rail 16, therefore, the thermally bonded electrode plate assembly 5 is effectively controlled to move back and forth between the first side 151 and the second side of the laminating platform 11.

Continuing to refer to FIG. 17 and FIG. 22, the laminating device 1 further includes a first monitor 91 and a second correction sensor 92. The first monitor 91 is located on a side of the first pressing mechanism 21, and the second correction sensor 92 is located on a side of the second pressing mechanism 22. The first monitor 91 and the second correction sensor 92 are both located in the spacing between the driving mechanism 30 and the laminating platform 11.

Through arranging the first monitor 91 and the second correction sensor 92 in the spacing between the driving mechanism 30 and the laminating platform 11, the first monitor 91 and the second correction sensor 92 can capture an entire falling and laminating process of the thermally bonded electrode plate assembly 5 during the falling and laminating process of the thermally bonded electrode plate assembly 5. The first monitor 91 is located on a side of the first pressing mechanism 21, and the second correction sensor 92 is located on a side of the second pressing mechanism 22. Therefore, the first monitor 91 can capture a pressing action provided to the thermally bonded electrode plate assembly 5 by the first pressing mechanism 21. The second correction sensor 92 can capture a pressing action provided to the thermally bonded electrode plate assembly 5 by the second pressing mechanism 22, so as to prevent the incorrect operation of the first pressing mechanism 21 and the second pressing mechanism 22 on the thermally bonded electrode plate assembly 5.

Embodiments of the present application further provide a thermally bonding device. The thermally bonding device includes the laminating device as described above and a hot rolling device. The hot rolling device is configured to perform hot rolling on positive electrode plates, diaphragms, and negative electrode plates to form thermally bonded units and provide the thermally bonded units to the laminating device.

The laminating device includes a pressing mechanism, the pressing mechanism can provide a constant tension to the thermally bonded electrode plate assembly located on the laminating platform, so that the thermally bonded electrode plate assembly is in a constant tension state, thereby effectively improving the alignment of the electrode plate assembly in the battery cell formed through laminating.

Compared with the laminating method in a Z-shaped pattern in related art, a negative electrode plate feeding device, a diaphragm feeding device, and diaphragm unwinding device, and a positive electrode plate feeding device are arranged on the laminating platform in sequence, and the diaphragms move back and forth on the laminating platform, thus the laminating efficiency is limited. In the thermally bonding device provided in the present application, the positive electrode plates, the diaphragms, and the negative electrode plates are hot rolled through the hot rolling device to form thermally bonded units, and the thermally bonding units are provided to the laminating device. The driving mechanism and the laminating platform in the laminating device can be configured to move towards each other, so that the laminating efficiency can be effectively improved.

In the laminating device provided in the present application, the falling and laminating process of the electrode plate assembly is controlled through both the first driving roller assembly and the second driving roller assembly, in which both the first driving roller assembly and the second driving roller assembly are configured for being able to clamp the electrode plate units. Through setting the first spacing between the first driving roller assembly and the second driving roller assembly to be less than the length L of each of the electrode plate units, or setting the first spacing d1 to be greater than the length L of each of the electrode plate units, and setting the ratio between d1 and L to be a non-positive integer, during the falling and laminating process of the electrode plate units, when the spaced area is located in one of the first driving roller assembly and the second driving roller assembly, the electrode plate units are located in another one of the first driving roller assembly and the second driving roller assembly, so that at least one of the first driving roller assembly and the second driving roller assembly can always provide a stable clamping effect on the electrode plate units, effectively preventing the electrode plate units from being out of control during the falling and laminating process.

In the processing method for an electrode plate assembly provided in the present application, the electrode plate assembly is processed through the laminating device as described above, and the falling and laminating process of the electrode plate assembly is driven and controlled through both the first driving roller assembly and the second driving roller assembly, so that the situation where a single driving roller assembly cannot provide effective clamping effect on the spaced area in the electrode plate assembly and make the falling and laminating process of the electrode plate assembly out of control can be effectively avoided.

The thermally bonding device provided in the present application is designed based on the laminating device as described above, and its beneficial effects are described in the beneficial effects of the laminating device as described above, which will not be repeated here.

What is claimed is:

1. A laminating device, being configured for processing an electrode plate assembly, the electrode plate assembly comprising a plurality of electrode plate units, the laminating device comprising:
a laminating platform, being configured for laminating the plurality of electrode plate units;
a driving mechanism, the driving mechanism comprising a first driving roller assembly and a second driving roller assembly, the first driving roller assembly and the second driving roller assembly being arranged at intervals on a same side of the laminating platform, and being configured for clamping the electrode plate assembly to drive the electrode plate assembly to move;
wherein a first spacing is arranged between the first driving roller assembly and the second driving roller assembly, the first spacing is set to be dl, a length of each of the electrode plate units is set to be L, d1 is less than L, or d1 is greater than L, and a ratio between d1 and L is a non-integer.

2. The laminating device of claim 1, wherein the first driving roller assembly comprises a first driving roller and a second driving roller arranged opposite to each other, and a second spacing is formed between the first driving roller and the second driving roller;
the second driving roller assembly comprises a third driving roller and a fourth driving roller arranged opposite to each other, and a third spacing is formed between the third driving roller and the fourth driving roller;
the second spacing and the third spacing are each set to be not greater than a thickness of each of the electrode plate units; and/or
the second spacing and the third spacing are each set to be 118 μm˜460 μm.

3. The laminating device of claim 2, wherein the second spacing is configured to be equal to the third spacing.

4. The laminating device of claim 2, further comprising a roller driving part, wherein the roller driving part is configured to drive the first driving roller assembly or the second driving roller assembly, the first driving roller and the third driving roller are configured as driving rollers, the second driving roller and the fourth driving roller are configured as driven rollers, the roller driving part is configured to be connected to the driving rollers and drive the driving rollers to rotate to drive the electrode plate assembly to move, an outer surface of one of the driving rollers and the driven rollers is configured to be soft and rough, and an outer surface of another of the driving rollers and the driven rollers is configured to be hard and smooth.

5. The laminating device of claim 1, wherein a rotation speed of the first driving roller assembly is set to be 1 rpm/min˜40 rpm/min, and the first driving roller assembly is configured to drive the thermally bonded electrode plate assembly in a movement speed of 1 m/min˜100 m/min; and/or
a rotation speed of the second driving roller assembly is set to be 1 rpm/min˜40 rpm/min, and the second driving roller assembly is configured to drive the thermally bonded electrode plate assembly in a movement speed of 1 m/min˜100 m/min; and/or
the rotation speed of the first driving roller assembly is set to be equal to the rotation speed of the second driving roller assembly.

6. The laminating device of claim 1, further comprising:
a first support platform and a second support platform, wherein the first driving roller assembly is mounted on the first support platform, the second driving roller assembly is mounted on the second support platform, the first driving roller assembly is configured to move on the first support platform, and/or, the second driving roller assembly is configured to move on the second support platform;
a first support frame and a second support frame arranged at intervals, wherein the first driving roller assembly is accommodated inside the first support frame, and the second driving roller assembly is accommodated inside the second support frame, the first support frame is fixed on the first support platform, and/or, the second support frame is fixed on the second support platform; and
a plurality of limiting parts arranged on the laminating platform, and the plurality of limiting parts are configured to limit a position of the thermally bonded electrode plate assembly, wherein positions of some of the limiting parts are adjustable;
wherein the first support frame, the second driving roller assembly, and the laminating platform are arranged parallel to each other in sequence, and the laminating platform is configured to move in a direction close to or away from the second support frame.

7. The laminating device of claim 6, further comprising at least two monitors arranged at intervals and configured to monitor the thermally bonded electrode plate assembly, wherein the at least two monitors are arranged between the second support platform and the laminating platform, one of the at least two monitors is located on one side of the second driving roller assembly, and another of the at least two monitors is located on another side of the second driving roller assembly.

8. The laminating device of claim 1, further comprising:
a receiving assembly, arranged below the driving mechanism in a vertical direction, wherein the receiving assembly comprises the laminating platform and limiting parts, the plurality of thermally bonded electrode plate units are bent and laminated on the laminating platform, the limiting parts are arranged at an edge of the laminating platform along a circumferential direction of the laminating platform, the limiting parts are configured to limit positions of the plurality of thermally bonded electrode plate units in a horizontal direction;
wherein the laminating platform is capable of vibrating in the horizontal direction to make edges of the plurality of thermally bonded electrode plate units be abutted against and aligned with the limiting parts; and
the receiving assembly further comprises a laminating platform driving part, and a driving end of the laminating platform driving part is connected to the laminating platform in a driving manner to drive the laminating platform to vibrate.

9. The laminating device of claim 8, further comprising:
a laminating platform position adjustment part, wherein the laminating platform position adjustment part comprises a first mounting part and a first adjusting part, the first adjusting part is movably arranged on the first mounting part, and the first adjusting part is fixedly connected to the laminating platform driving part and move in a first direction with the laminating platform driving part; and
a driving roller position adjusting part, wherein the driving roller position adjusting part comprises a second mounting part and a second adjusting part, the second adjusting part is movably arranged on the second mounting part, and the second adjusting part is fixedly connected to the first driving roller assembly or the second driving roller assembly and drives the first driving roller assembly or the second driving roller assembly to move along the first direction;
wherein the first driving roller assembly comprises a first driving roller and a second driving roller arranged opposite to each other, the second driving roller assembly comprises a third driving roller and a fourth driving roller arranged opposite to each other, and/or a rotation direction of the first driving roller is opposite to a rotation direction of the second driving roller, and a rotation direction of the third driving roller is opposite to a rotation direction of the fourth driving roller; and
the first driving roller assembly or the second driving roller assembly further comprises a roller driving part, a driving end of the roller driving part is connect to one of the first driving roller and the second driving roller in a driving manner, and the first driving roller is in transmission connection to the second driving roller to rotate simultaneously; or, the driving end of the roller driving part is connect to one of the third driving roller and the fourth driving roller in a driving manner, and the third driving roller is in transmission connection to the fourth driving roller to rotate simultaneously.

10. The laminating device of claim 9, further comprising a monitor, wherein the monitor is arranged between the driving mechanism and the receiving assembly, the monitor is configured to monitor the positions of the thermally bonded electrode plate units, the monitor is in communication with both the laminating platform position adjustment part and the driving roller position adjusting part, and the laminating platform position adjustment part and the driving roller position adjusting part receive signal from the monitor to adjust the positions of the thermally bonded electrode plate units;
wherein there are two monitor, and the two monitors are arranged opposite to each other on two sides of the thermally bonded electrode plate units in the horizontal direction.

11. The laminating device of claim 10, further comprising a side plate, wherein the laminating platform position adjustment part and the driving roller position adjusting part are both fixed on the side plate.

12. The laminating device of claim 1, further comprising:
at least one pressing mechanism, wherein the pressing mechanism comprises a first pressing mechanism arranged on a first side of the laminating platform, the first pressing mechanism comprises a first pressing device and a second pressing device arranged opposite to each other, a spacing between the first pressing device and the second pressing device is greater than or equal to a width of one of the thermally bonded electrode plate units, the first pressing device is pressed on one side of the thermally bonded electrode plate unit, and the second pressing device is pressed on another side of the thermally bonded electrode plate unit; wherein the one side of the thermally bonded electrode plate unit and the another side of the thermally bonded electrode plate unit are arranged opposite to each other, and a spacing between the one side of the thermally bonded electrode plate unit and the another side of the thermally bonded electrode plate unit is set to be equal to the width of the thermally bonded electrode plate unit.

13. The laminating device of claim 12, wherein the spacing between the first pressing device and the second pressing device is set to be 100 mm ˜ 600 mm; and
the at least one pressing mechanism further comprises a second pressing mechanism arranged on a second side of the laminating platform, the second pressing mechanism comprises a third pressing device and a fourth pressing device arranged opposite to each other, a spacing between the third pressing device and the fourth pressing device is equal to the width of the thermally bonded electrode plate unit, and the first side and the second side are arranged opposite to each other;
in case that the thermally bonded electrode plate unit is located on the first side of the laminating platform, the first pressing mechanism is configured for pressing the thermally bonded electrode plate unit; in case that the thermally bonded electrode plate unit is located on the second side of the laminating platform 11, the second pressing mechanism is configured for pressing the thermally bonded electrode plate unit.

14. The laminating device of claim 13, wherein the first pressing device, the second pressing device, the third pressing device, and the fourth pressing device each comprise a driving part and a pressing part; the pressing part comprises a connecting portion connected to the driving part, and a pressing portion connected to the connecting portion;
the driving part is configured to drive the pressing portion to move in a direction close to or away from the laminating platform, and an extension direction of the pressing portion is configured to be same as a width direction of the thermally bonded electrode plate unit;
the first pressing device comprises a first pressing part, the first pressing part comprises a first pressing portion, the second pressing device comprises a second pressing part, the second pressing part comprises a second pressing portion, and an extension direction of the first pressing portion is opposite to an extension direction of the second pressing portion; and/or the third pressing device comprises a third pressing portion, the fourth pressing device comprises a fourth pressing portion, and an extension direction of the third pressing part is opposite to an extension direction of the fourth pressing portion; and
a length of the first pressing portion extending along the width direction of the thermally bonded electrode plate unit is d1, a length of the second pressing portion extending along the width direction of the thermally bonded electrode plate unit is d2, a width of the thermally bonded electrode plate unit is w, and (d1+d2)/w satisfies: 1/40≤(d1+d2)/w≤1/30; and/or
a length of the third pressing portion extending along the width direction of the thermally bonded electrode plate unit is d3, a length of the fourth pressing portion extending along the width direction of the thermally bonded electrode plate unit is d4, a width of the thermally bonded electrode plate unit is w, and (d3+d4)/w satisfies: 1/40≤(d3+d4)/w≤1/30.

15. The laminating device of claim 13, further comprising a first baffle arranged on the first side of the laminating platform, and a second baffle arranged on the second side of the laminating platform; wherein the first pressing mechanism is located on a side of the first baffle, and the second pressing mechanism is located on a side of the second baffle; a length of the first baffle extending along a first side of the laminating platform is less than a spacing between the first pressing device and the second pressing device; and/or, a length of the second baffle extending along the first side of the laminating platform is less than a spacing between the third pressing device and the fourth pressing device;
wherein the driving mechanism is arranged on the laminating platform, and the first driving roller assembly or the second driving roller assembly and the laminating platform are configured to move towards each other.

16. The laminating device of claim 15, wherein the driving mechanism comprises a first guide rail configured for the first driving roller assembly or the second driving roller assembly to move, the laminating device further comprises a second guide rail configured for movement of the laminating platform, and an extending length of the first guide rail is greater than an extending length of the second guide rail.

17. The laminating device of claim 15, further comprising a first monitor and a second correction sensor, the first monitor and the second correction sensor are located in a spacing between the driving mechanism and the laminating platform, the first monitor is located on a side of the first pressing mechanism, and the second correction sensor is located on a side of the second pressing mechanism.

18. A processing method for an electrode plate assembly, the electrode plate assembly being processed through a laminating device, the laminating device being configured for processing an electrode plate assembly, the electrode plate assembly comprising a plurality of electrode plate units, the laminating device comprising: a laminating platform, being configured for laminating the plurality of electrode plate units; a driving mechanism, the driving mechanism comprising a first driving roller assembly and a second driving roller assembly, the first driving roller assembly and the second driving roller assembly being arranged at intervals on a same side of the laminating platform, and being configured for clamping the electrode plate assembly to drive the electrode plate assembly to move; wherein a first spacing is arranged between the first driving roller assembly and the second driving roller assembly, the first spacing is set to be d1, a length of each of the electrode plate units is set to be L, d1 is less than L, or d1 is greater than L, and a ratio between d1 and Lis a non-integer; and
the processing method comprising:
driving the thermally bonded electrode plate units through both the first driving roller assembly and the second driving roller assembly to move in a direction close to the laminating platform to make the thermally bonded electrode plate units pass through the first driving roller assembly and the second driving roller assembly in sequence;
wherein one of the thermally bonded electrode plate units comprises a positive electrode plate, a first diaphragm, a negative electrode plate, and a second diaphragm laminated in sequence; and
laminating the plurality of electrode plate units through the laminating platform to form a battery cell pack.

19. The processing method for the electrode plate assembly of claim 18, further comprising:
adjusting a position of the first driving roller assembly on a first support platform, and/or, adjusting a position of the second driving roller assembly on the second support platform, and adjusting positions of the electrode plate units relative to the laminating platform.

20. A thermally bonding device, the thermally bonding device comprising a laminating device and a hot rolling device, the laminating device being configured for processing an electrode plate assembly, the electrode plate assembly comprising a plurality of electrode plate units, the laminating device comprising: a laminating platform, being configured for laminating the plurality of electrode plate units; a driving mechanism, the driving mechanism comprising a first driving roller assembly and a second driving roller assembly, the first driving roller assembly and the second driving roller assembly being arranged at intervals on a same side of the laminating platform, and being configured for clamping the electrode plate assembly to drive the electrode plate assembly to move; wherein a first spacing is arranged between the first driving roller assembly and the second driving roller assembly, the first spacing is set to be d1, a length of each of the electrode plate units is set to be L, d1 is less than L, or d1 is greater than L, and a ratio between d1 and L is a non-integer; and
the hot rolling device being configured to perform hot rolling on the positive electrode plates, the diaphragms and the negative electrode plates to form the thermally bonded units and provide the thermally bonded units to the laminating device.
